(19) United States
(12) Patent Application Publication
(10) Pub. No.: US 2019/0184715 A1
(43) Pub. Date: Jun. 20, 2019

(54) METHODS FOR DIGITAL PRINTING ON PRODUCTS MADE FROM PAPER, POLYETHYLENE OR OTHER MATERIALS

(71) Applicants: Steve Kohn, Short Hills, NJ (US); Luis DeOlivera, Lanoka Harbor, NJ (US)

(72) Inventors: Steve Kohn, Short Hills, NJ (US); Luis DeOlivera, Lanoka Harbor, NJ (US)

(21) Appl. No.: 16/285,375

(22) Filed: Feb. 26, 2019

Related U.S. Application Data
(63) Continuation-in-part of application No. 16/121,430, filed on Sep. 4, 2018.
Application No. 16/121,430 is a continuation-in-part of application No. 15/696,987, filed on Sep. 6, 2017.

(30) Foreign Application Priority Data
Mar. 4, 2015 (JP) 2015-042687

(51) Int. Cl. B41J 3/407; B41J 2/14; B41J 2/21

(52) U.S. Cl. CPC B41J 3/4073; B41J 2/21; B41J 2/14201

(57) ABSTRACT

Systems and methods for printing from a digital-based image directly onto products made from paper, polyethylene, or other materials

### RELATED APPLICATIONS

This application is a continuation-in-part of application Ser. No. 16/121,430 filed Sep. 4, 2018; which is a continuation-in-part of application Ser. No. 15/698,987 filed Sep. 8, 2017.

### FIELD OF THE INVENTION

The present invention relates to methods for printing from a digital-based image directly onto products made from paper, polyethylene, or other materials.

### BACKGROUND OF THE INVENTION

Printed and unprinted flexible and semi-rigid packaging materials are commonly used for packing retail, industrial, and commercial products into plastic bags, paper bags, sacks, pouches, wrappers, and the like. Printed and unprinted flexible and semi-rigid packaging materials are also commonly used for covering or storing retail, industrial, and commercial products. Desired features of packaging materials include printability and different levels of opacity. Packaging materials can either be printed or imprinted. Printed packaging materials can use a single color or multiple colors. Graphics printed on the packaging materials can include company logos, association logos, advertising and text. Graphics can be used to communicate promotional or educational messages.

Offset printing is a commonly used printing technique for printing images, graphics and/or text on printed surfaces such as paper bags. Offset printing occurs when an inked area is transferred from a metal or rubber plate to a rubber cylinder (commonly called a “blanket”), and then transferred to a printing surface such as paper. The process is called “offset” because the inked image is offset or transferred to something else first (e.g. the rubber blanket) before being transferred directly to the printed surface.

Offset commercial printing presses and inkjet desktop printers both use some combination of the following ink colors: cyan (“C”), magenta (“M”), yellow (“Y”), and black (“K”). Offset printing is also typically referred to as 4-color printing or 4-color process lithography.

With offset printing, separate plates are created for each color. The plates are then put onto a press. The press pulls in the ink from ink reservoirs and puts the ink onto the plate. The press then applies pressure to the plate and the ink imprints the image from the plate onto a rubber blanket. The image is then pressed onto the paper off the blanket to make a print. Often, the ink also permeates the substrate being printed on, resulting in “bleed through” and an unacceptable end product. Offset printing occurs very rapidly and is best suited for long runs over a long period of time and for producing many items with the same printed image.

Digital printing refers to methods of printing from a digital-based image onto a surface or substrate, without requiring the need for separate, analog plates. Unlike conventional ink used in offset printing, the ink or toner used in digital printing does not permeate the substrate, but forms a thin layer on the surface. Digital printing allows for on demand printing, short turnaround time, and simple modifications of the image used for each impression (variable image printing).

Digital printing can use computers, tablets, or mobile devices to stream data to inkjet printers for printing. Inkjet print heads inside the printer fire or spray fine dots of ink at a surface to create an image, images, or text. One type of inkjet prim head fires ink towards a printing surface by heating the ink so it explodes on the surface in bubbles. Another type of inkjet print head uses piezoelectricity, whereby tiny electric currents cause miniature crystals to jiggle back and forth, firing dots of ink at a surface.

Digital printing can also use computers, tablets, or mobile devices to stream data to laser printers for printing. Electronic circuits in the printer make a laser beam move back and forth across a drum inside the printer, causing static electricity to attract a powdered ink or toner to the printed surface. A fuser then bonds the toner to the surface, resulting in a printed image, images or text on the surface.

U.S. Pat. No. 5,795,280 relates to an apparatus for facilitating the registration of printed matter during the manufacture of bags on fixed-size bag formation equipment, from a continuous web of a substantially non-stretchable material. Printed matter, printed upon the continuous web at regularly-spaced intervals, includes a plurality of periodically spaced reference markers.

U.S. Pat. No. 8,840,240 relates to a paper conveyance device for a printing device that includes a detector and conveyance mechanisms. The device includes a print head and feed and pressure rollers.

U.S. Pat. No. 8,857,978 relates to a paper conveyance device for a printing device that print information using a printhead on conveyed continuous paper including a paper conveyance mechanism that holds and conveys the continuous paper to the print area of the printhead, and a guide unit that has two guide surfaces facing the conveyed continuous paper.

U.S. Pat. No. 8,899,740 relates to a print medium conveyance device having a tractor, conveyance roller, and clutch mechanism. The tractor engages engagement holes formed in a line in the medium and conveys the print medium in a specific direction. The print medium can be conveyed with high precision,

U.S. patent publication no, 20030173716 relates to a colored polyolefin film printed by digital printing. The colored polyolefin film is formed by blending a coloring agent with a polyolefin, and forming a film from the blend by an extrusion process. Digital signals are supplied to a printer adapted to respond to such signals to print the colored film. Indicia may be placed on the surface of the colored film by electrostatic printing, thermal transfer printing or ink jet printing, especially with UV curable ink jet ink. The colored polyolefin film may be a multi-layer film having an opaque, cavitated core layer and at least one colored skin or tie layer.

U.S. patent publication no. 20050115200 relates to a package paper thermal printer of a tablet packing machine for printing information about prescription medicines on package paper by a thermal printhead and a ribbon tape. The thermal print head and ribbon tape are raised together so as to closely attach the ribbon tape to a lower surface of the package paper passing under the contact roller, so that information inputted into the thermal print head is transferred to the package paper by heat and characters are printed on the package paper when the actuating plate is raised.

U.S. patent publication no. 20020191036 relates to an ink jet printer for digital textile printing which uses a flat table instead of a conventional roll. An ink jet printer has a transporter part to transport an object to be printed through a path and printing part to perform the digital printing by jetting ink drops to the object. The transporting part comprises a transporting table on which the object is fixed and transported, a transporting means for transporting the table to the printing part, and a driving means for operating the transporting means.

U.S. patent publication no, 20080118746 relates to a low-cost method of coating low density polyethylene, linear low density polyethylene or combinations. The method includes treating the polyethylene with a coating and then digitally printing the coated polyethylene substrate. The coated substrate may then be overcoated to protect the printing and the substrate may then be formed. The substrate may form a small tote bag.

U.S. patent publication no. 20130324386 relates to a bag making machine with a feeder to unwind and feed a sheet in a first direction, a forming device to bend and fold the sheet to form a tubular body, a speed controller for controlling upstream and downstream speeds of advancement of the tubular body, a cutter to cut the tubular body into a plurality of tubular pieces, a direction changing device to change direction of advancement of the tubular pieces, a sewing device to close bottom side of each tubular piece and sealing device. A printing device includes a printer near the feeder to print a pattern on the surface of the fabric sheet.

U.S. patent publication no. 2011/0079531 relates to a packaging film with at least one section comprising a single or multi-layered substrate, a printed functional layer formed from a printable material forming at least in sections an outer layer of the packaging film section. The invention concerns a packaging and a packaging product unit.

U.S. patent publication no. 2015/0199786 relates to a bag that includes a flexible web in the shape of a bag and a communication member or other advertising media attached to the flexible web with an adhesive. An advertising medium includes a packaging material made of a first material and a communication member applied to the packaging material.

### SUMMARY OF THE INVENTION

The present invention relates to a method for digital printing of graphics and/or text on flexible and semi-rigid packaging materials. It is an object of the present invention for the packaging materials to comprise paper products such as bags, corrugate, and cardboard and cartons. It is an object of the present invention for the packaging materials to comprise polyethylene products such as t-sacks, sheeting, tubing, covers such as furniture covers and dust covers, and storage bags such as mattress bags and food pouches. It is an object of the present invention for the packaging materials to be made from paper, polyethylene or other packaging material.

The present invention relates to a method of digital printing of graphics and/or text on pinch bottom bags and flat bottom bags. A pinch bottom bag comprises a tubular envelope closed at one end by a single glued flap. A flat bottom bag comprises a tubular envelope closed at one end by glued flaps that form a flat bottom. It is an object of the present invention for a pinch bottom bag or flat bottom bag to be made from a flexible material such as paper or polyethylene.

It is an object of the present invention to digitally print single or multiple color graphics and text on flexible and semi-rigid packaging materials. It is an object of the present invention to digitally print single or multiple color graphics or text on flexible and semi-rigid packaging materials. It is an object of the present invention that the packaging materials comprise paper, polyethylene or other packaging material.

It is an object of the present invention to digitally print single or multiple color graphics and text on flexible and semi-rigid packaging materials before converting the materials into finished products (pre-printing). It is an object of the present invention to digitally print single or multiple color graphics and text on flexible and semi-rigid packaging materials after converting the materials into finished products (post-printing).

It is an object of the present invention to digitally print single or multiple color graphics or text on flexible and semi-rigid packaging materials before converting the materials into finished products (pre-printing). It is an object of the present invention to digitally print single or multiple color graphics or text on flexible and semi-rigid packaging materials after converting the materials into finished products (post-printing).

It is an object of the present invention to digitally print on flexible and semi-rigid paper packaging material such as rolls of bags, bags, sheets of corrugate, corrugate, sheets of cardboard, cardboard and cartons.

The present invention relates to a method that comprises using a separate digital printing system to pre-print single or multiple color graphics and/or text on rolls of paper used to make paper bags. It is an object of the present invention for the method to comprise using a separate digital printing system to pre-print on rolls of paper prior to the paper being fed to a bag machine for producing pinch bottom bags. It is an object of the present invention for the method to comprise using a separate digital printing system to preprint on rolls of paper prior to the paper being fed to a bag machine for producing flat bottom bags. It is an object of the present invention for the method to comprise a digital printing system depositing ink or toner onto the surface of the paper to form an image (pre-printing) before converting the paper to bags. It is an object of the present invention for the ink or toner to form a thin layer on the surface of the paper. It is an object of the present invention for the ink or toner to be adhered to the bags by using a fuser fluid. It is an object of the present invention for the ink or toner to be adhered to the bags by using heat. It is an object of the present invention for the ink or toner to be adhered to the bags by using UV curing. It is an object of the present invention for the ink or toner to be adhered to the bags by using some combination of fuser fluid, heat or UV curing. It is an object of the present invention for the digital printing system to pint continuously on the paper as it is unrolled and fed to a bag machine. It is an object of the present invention for the digital printing system to print repeated images of the graphics and/or text on the paper. It is an object of the present invention for the digital printing system to print graphics and/or text on the paper so that when the bag material is formed into bags, the image or text is in the same location on every bag produced.

The present invention relates to a method that comprises using a digital printing system to post-print single or multiple color graphics and/or text on paper bags. It is an object of the present invention for the method to comprise taking paper pinch bottom bags already separately produced on a bag machine and feeding the bags to a separate digital printing system. It is an object of the present invention for the method to comprise taking paper fiat bottom bags already separately produced on a bag machine and feeding the bags to a separate digital printing system. It is an object of the present invention for the method to comprise taking paper pinch bottom bags already separately produced on a bag machine and post-printing on the bags by using a separate digital printing system. It is an object of the present invention for the method to comprise taking paper flat bottom bags already separately produced on a bag machine and post-printing on the bags by using a separate digital printing system. It is an object of the present invention for the method to comprise the digital printing system depositing ink or toner onto the bag surface to form an image. It is an object of the present invention for the ink or toner to form a thin layer on the surface of the bag. It is an object of the present invention for the ink or toner to be adhered to the bags by using a fuser fluid. It is an object of the present invention for the ink or toner to be adhered to the bags by using heat. It is an object of the present invention for the ink or toner to be adhered to the bags by using UV curing. It is an object of the present invention for the ink or toner to be adhered to the bags by using some combination of fuser fluid, heat, or UV curing.

The present invention relates to a method that comprises using a digital printing system with an integrated feed to post-print single or multiple color graphics and/or text on paper bags. It is an object of the present invention for the method to comprise automatically flowing previously produced paper pinch bottom bags through an integrated feed mechanism on an attached digital printing system to digitally print the bags. It is an object of the present invention for the method to comprise automatically flowing previously produced paper flat bottom bags through an integrated feed mechanism on an attached digital printing system to digitally print the bags. It is an object of the present invention to place bags to be printed in a storage unit such as a drawer or tray connected to the digital printing system. It is an object of the present invention that the bags to be printed be automatically withdrawn from the storage unit and fed to the digital printing system. It is an object of the present invention that the bags to be printed are fed individually to the digital printing system via a conveyor belt or similar transporting system. It is an object of the present invention that the bags to be printed are fed to the digital printing system through an automatic feeding system located on top of the digital printing system. It is an object of the present invention for a digital printing system to deposit ink or toner onto the bag surface to form an image. It is an object of the present invention for the ink or toner to form a thin layer on the surface of the bags. It is an object of the present invention for the ink or toner to be adhered to the bags by using a fuser fluid. It is an object of the present invention for the ink or toner to be adhered to the bags by using heat. It is an object of the present invention for the ink or toner to be adhered to the bags by using UV curing. It is an object of the present invention for the ink or toner to be adhered to the bags by using sonic combination of fuser fluid, heat or UV curing.

The present invention relates to a method for digitally printing on flexible and semi-rigid polyethylene packaging materials including such materials as polyethylene film, sheets, tubing and bags. It is an object of the present invention to digitally print on flexible and semi-rigid polyethylene products such as plastic t-sacks, sheeting, tubing, bags, covers such as furniture covers and dust covers, and storage bags such as mattress bags and food pouches. It is an object of the present invention for any of these products to have an antimicrobial component added to it.

The present invention relates to a method for using a separate digital printing system to pre-print single or multiple color graphics and/or text on sheets or rolls of polyethylene film used to make products such as bags, t-sacks and pouches. It is an object of the present invention for the method to comprise using a separate digital printing system to deposit ink or toner onto the surface of the polyethylene sheets or rolls to form an image (pre-printing) before converting the polyethylene material to a product such as bags. It is an object of the present invention for the ink or toner to form a thin layer on the surface of the polyethylene material. It is an object of the present invention for the ink or toner to be adhered to the product by using a fuser fluid. It is an object of the present invention for the ink or toner to be adhered to the product by using heat. It is an object of the present invention for the ink or toner to be adhered to the product by using UV curing. It is an object of the present invention for the ink or toner to be adhered to the product by using fuser fluid, heat, UV curing or any combination. It is an object of the present invention for the digital printing system to print continuously on the polyethylene material. It is an object of the present invention for the digital printing system to print repeated images of the graphics and/or text on the polyethylene material. It is an object of the present invention for the digital printing system to print graphics and/or text on the polyethylene so that when the polyethylene material is formed into products such as bags, the image or text is in the same location on every product produced.

The present invention relates to a method for using a digital printing system to post-print single or multiple color graphics and/or text on polyethylene products such as bags. It is an object of the present invention for the method to comprise taking polyethylene bags already separately produced on a bag machine and feeding the bags to a separate digital printing system. It is an object of the present invention for the method to comprise taking polyethylene bags already separately produced on a bag machine and post-printing on the bags by using a separate digital printing system. It is an object of the present invention for the method to comprise the digital printing system depositing ink or toner onto the bag surface to form an image. It is an object of the present invention for the ink or toner to form a thin layer on the surface of the bags. It is an object of the present invention for the ink or toner to be adhered to the bags by using a fuser fluid. It is an object of the present invention for the ink or toner to be adhered to the bags by using heat. It is an object of the present invention for the ink or toner to be adhered to the bags by using UV curing. It is an object of the present invention for the ink or toner to be adhered to the bags by using some combination of fusing fluid, heat, or UV curing.

The present invention comprises a method to use a digital printing system with an integrated feed to post-print single or multiple color graphics and/or text on polyethylene products such as bags. It is an object of the present invention for the method to comprise automatically flowing previously produced polyethylene products such as bags through an integrated feed mechanism on an attached digital printing system to digitally print the bags. It is an object of the present invention to place bags to be printed in a storage unit such as a drawer or tray connected to the digital printing system. It is an object of the present invention that the bags to be printed be automatically withdrawn from the storage unit and fed to the digital printing system. It is an object of the present invention that the bags to be printed are fed individually to the digital printing system via a conveyor belt or similar transporting system. It is an object of the present invention that the bags to be printed are fed to the digital printing system through an automatic feeding system located on top of the digital printing system. It is an object of the present invention for the method to comprise a digital printing system depositing ink or toner onto the bag surface to form an image. It is an object of the present invention for the ink or toner to form a thin layer on the surface of the bag. It is an object of the present invention for the ink or toner to be adhered to the bags by using a fuser fluid. It is an object of the present invention for the ink or toner to be adhered to the bags by using heat. It is an object of the present invention for the ink or toner to be adhered to the bags by using UV curing. It is an object of the present invention for the ink or toner to be adhered to the bags by using some combination of fuser fluid, heat, or UV curing.

The present invention relates to a method that comprises using a digital printing system to post-print single or multiple color graphics and/or text on paper pinch bottom bags. It is an object of the present invention for the method to comprise taking unprinted paper pinch bottom bags already separately produced on a bag machine and feeding the bags to a separate digital. printing system. It is an object of the present invention for the method to comprise taking unprinted paper pinch bottom bags already separately produced on a bag machine and post-printing on the bags by using a separate digital printing system. It is an object of the present invention for the method to comprise taking preprinted paper pinch bottom bags already separately produced on a bag machine and feeding the bags to a separate digital printing system for additional printing. It is an object of the present invention for the method to comprise taking preprinted paper pinch bottom bags already separately produced on a bag machine and post-. printing on the bags by using a separate digital printing system.

The present invention relates to a method that comprises using a digital printing system to post-print single or multiple color graphics and/or text on paper flat bottom bags. It is an object of the present invention for the method to comprise taking unprinted paper flat bottom bags already separately produced on a bag machine and feeding the bags to a separate digital printing system. It is an object of the present invention for the method to comprise taking preprinted paper flat bottom bags already separately produced on a bag machine and feeding the bags to a separate digital printing system for additional printing. It is an object of the present invention for the method to comprise taking unprinted paper flat bottom bags already separately produced on a bag machine and post-printing on the bags by using a separate digital printing system. It is an object of the present invention for the method to comprise taking preprinted paper flat bottom bags already separately produced on a bag machine and post-printing on the bags by using a separate digital printing system.

The present invention relates to a method that comprises using a digital printing system to deposit ink or toner onto the surface of an unprinted bag to form an image, images or text. It is an object of the present invention for the method to comprise the digital printing system depositing ink or toner onto the unprinted bag surface to form an image, images or text. It is an object of the present invention for the method to comprise the digital printing system depositing ink or toner onto the unprinted paper pinch bottom bags surface to form an image, images or text. It is an object of the present invention for the method to comprise the digital printing system depositing ink or toner onto the unprinted paper flat bottom bags surface to form an image, images or text.

The present invention relates to a method that comprises using a digital printing system to deposit ink or toner onto the surface of a preprinted bag to form an image, images or text other than what is already preprinted on the bag. It is an object of the present invention for the method to comprise the digital printing system depositing ink or toner onto the preprinted bag surface to form an image, images or text other than what is already preprinted on the bag. It is an object of the present invention for the method to comprise the digital printing system depositing ink or toner onto the preprinted paper pinch bottom bag surface to form an image, images or text other than what is already preprinted on the bag. It is an object of the present invention for the method to comprise the digital printing system depositing ink or toner onto the preprinted paper flat bottom bag surface to form an image, images or text other than what is already preprinted on the bag.

The present invention relates to a method that comprises a digital printing system that uses inkjet printing to deposit ink against the surface on which the print takes place.

It is an object of the present invention for the method that comprises the digital printing system to use inkjet printing featuring print heads or print cartridges that each have a single jetting array that deposits a single color of ink onto a surface such as a paper bag. It is an object of the present invention for the method that comprises the digital printing system to use inkjet printing featuring print heads or print cartridges that each have multiple jetting arrays, with each jetting array depositing a single color of ink onto a surface such as a paper bag. It is an object of the present invention for the method that comprises the digital printing system to use inkjet printing featuring CMYK print heads or print cartridges that each have up to four jetting arrays, with each jetting array depositing a single color of ink onto a surface such as a paper bag. It is an object of the present invention for the method that comprises the digital printing system to use inkjet printing featuring CMYK print heads or print cartridges that each have up to 32 jetting arrays, with each jetting array depositing a single color of ink onto a surface such as a paper bag.

It is an object of the present invention for the method that comprises the digital printing system to use inkjet printing featuring CMYK print heads or print cartridges that each have up to 32 jetting arrays to deposit ink on a printed surface such as a paper bag. It is an object of the present invention for the method that comprises the digital printing system to use inkjet printing featuring CMYK print heads or print cartridges that each have up to 32 jetting arrays to deposit ink on a printed surface such as a paper bag, yielding a vertical DPI up to 600. It is an object of the present invention for the method that comprises the digital printing system to use inkjet printing featuring CMYK print heads or print cartridges that each have up to 32 jetting arrays to deposit ink on a printed surface such as a paper bag, yielding a vertical DPI up to 900. It is an object of the present invention for the method that comprises the digital printing system to use inkjet printing to increase the number of jetting arrays in a print head or print cartridge to increase the vertical DPI. It is an object of the present invention for the method that comprises the digital printing system to use inkjet printing to decrease the number of jetting arrays in a print head or print cartridge to decrease the vertical DPI.

It is an object of the present invention for the method that comprises the digital printing system to use inkjet printing featuring a single print head or print cartridge with a vertical print capacity or width of up to six inches on a surface such as a paper bag. It is an object of the present invention for the method that comprises the digital printing system to use inkjet printing featuring at least two print heads to achieve a vertical print capacity or width of up to six inches on a surface such as a paper bag. It is an object of the present invention for the method that comprises the digital printing system to use inkjet printing featuring at least two print heads stitched together to achieve a vertical print capacity or width of up to six inches on a surface such as a paper bag.

It is an object of the present invention for the method that comprises the digital printing system to use inkjet printing featuring at least two print heads to achieve a vertical print capacity or width of up to twelve inches on a surface such as a paper bag. It is an object of the present invention for the method that comprises the digital printing system to use inkjet printing featuring at least two print heads stitched together to achieve a vertical print capacity or width of up to twelve inches on a surface such as a paper bag.

It is an object of the present invention for the method that comprises the digital printing system to use inkjet printing featuring multiple print heads to achieve a vertical print capacity or width of up to six inches on a surface such as a paper bag. It is an object of the present invention for the method that comprises the digital printing system to use inkjet printing featuring multiple print heads stitched together to achieve a vertical print capacity or width of up to six inches on a surface such as a paper bag.

It is an object of the present invention for the method that comprises the digital printing system to use inkjet printing featuring multiple print heads to achieve a vertical print capacity or width of up to twelve inches on a surface such as a paper bag. It is an object of the present invention for the method that comprises the digital printing system to use inkjet printing featuring multiple print heads stitched together to achieve a vertical print capacity or width of up to twelve inches on a surface such as a paper bag.

It is an object of the present invention for the method that comprises the digital printing system to use inkjet printing featuring multiple print heads to achieve a vertical print capacity or width of up to eighteen inches on a surface such as a paper bag. It is an object of the present invention for the method that comprises the digital printing system to use inkjet printing featuring multiple print heads stitched together to achieve a vertical print capacity or width of up to eighteen inches on a surface such as a paper bag.

It is an object of the present invention for the method that comprises the digital printing system to use inkjet printing featuring a single print head or print cartridge that deposits ink onto paper pinch bottom bags. It is an object of the present invention for the method that comprises the digital printing system to use inkjet printing featuring multiple print heads or print cartridges that deposit ink onto paper pinch bottom bags. It is an object of the present invention for the method that comprises the digital printing system to use inkjet printing featuring a single print head or print cartridge that deposits ink onto paper pinch bottom bags to form an image, images or text. It is an object of the present invention for the method that comprises the digital printing system to use inkjet printing featuring multiple print heads or print cartridges that deposit ink onto paper pinch bottom bags to form an image, images or text. It is an object of the present invention for the method that comprises the digital printing system to use inkjet printing featuring print heads or print cartridges that deposit ink onto paper pinch bottom bags to form an image, images or text by forcing ink through a nozzle or similar device. It is an object of the present invention for the method that comprises the digital printing system to use inkjet printing featuring drop-on-demand print heads such as thermal print heads and non-thermal print heads to deposit ink onto paper pinch bottom bags to form image, images or text. It is an object of the present invention for the method that comprises the digital printing system to use inkjet printing featuring print heads such as thermal print heads and non-thermal print heads to deposit ink onto paper pinch bottom bags to form an image, images or text. It is an object of the present invention for the method that comprises the digital printing system to use inkjet printing featuring a combination of different types of print heads such as thermal print heads and non-thermal print heads to deposit ink onto paper pinch bottom bags to form an image, images or text.

It is an object of the present invention for the method that comprises the digital printing system to use inkjet printing featuring a single print head or print cartridge that deposits ink onto unprinted paper pinch bottom bags. It is an object of the present invention for the method that comprises the digital printing system to use inkjet printing featuring multiple print heads or print cartridges that deposit ink onto unprinted paper pinch bottom bags. It is an object of the present invention for the method that comprises the digital printing system to use inkjet printing featuring a single print head or print cartridge that deposits ink onto unprinted paper pinch bottom bags to form an image, images or text. It is an object of the present invention for the method that comprises the digital printing system to use inkjet printing featuring multiple print heads or print cartridges that deposit ink onto unprinted paper pinch bottom bags to form an image, images or text. It is an object of the present invention for the method that comprises the digital printing system to use inkjet printing featuring print heads or print cartridges that deposit ink onto unprinted paper pinch bottom bags to form an image, images or text by forcing ink through a nozzle or similar device. It is an object of the present invention for the method that comprises the digital printing system to use inkjet printing featuring drop-on-demand print heads such as thermal print heads and non-thermal print heads to deposit ink on imprinted paper pinch bottom bags to form an image, images or text. It is an object of the present invention for the method that comprises the digital printing system to use inkjet printing featuring print heads such as thermal print heads and non-thermal print heads to deposit ink onto imprinted paper pinch bottom bags to form an image, images or text. It is an object of the present invention for the method that comprises the digital printing system to use inkjet printing featuring a combination of different types of print heads such as thermal print heads and non-thermal print heads to deposit ink onto unprinted paper pinch bottom bags to form an image, images or text.

It is an object of the present invention for the method that comprises the digital printing system to use inkjet printing featuring a single print head or print cartridge that deposits ink onto preprinted paper pinch bottom bags. It is an object of the present invention for the method that comprises the digital printing system to use inkjet printing featuring multiple print heads or print cartridges that deposit ink onto preprinted paper pinch bottom bags. It is an object of the present invention for the method that comprises the digital printing system to use inkjet printing featuring a single print head or print cartridge that deposit inks onto preprinted paper pinch. bottom bags to form an image, images or text other than what is already preprinted on the bags. It is an object of the present invention for the method that comprises the digital printing system to use inkjet printing featuring multiple print heads or print cartridges that deposit ink onto preprinted paper pinch bottom bags to form an image, images or text other than what is already preprinted on the bags. It is an object of the present invention for the method that comprises the digital printing system to use inkjet printing featuring print heads or print cartridges that deposit ink onto preprinted paper pinch bottom bags to form an image, images or text other than what is already preprinted on the bags by forcing ink through a nozzle or similar device. It is an object of the present invention for the method that comprises the digital printing system to use inkjet printing featuring drop-on-demand print heads such as thermal print heads and non-thermal print heads to deposit ink on preprinted paper pinch bottom bags to form an image, images or text other than what is already preprinted on the bags. It is an object of the present invention for the method that comprises the digital printing system to use inkjet printing featuring print heads such as thermal print heads and non-thermal print heads to deposit ink onto preprinted paper pinch bottom bags to form an image, images or text other than what is already preprinted on the bags. It is an object of the present invention for the method that comprises the digital printing system to use inkjet printing featuring a combination of different types of print heads such as thermal print heads and non-thermal print heads to deposit ink onto preprinted paper pinch bottom bags to form an image, images or text other than what is already preprinted on the bags.

It is an object of the present invention for the method that comprises the digital printing system to use inkjet printing featuring a single print head or print cartridge that deposits ink onto paper flat bottom bags. It is an object of the present invention for the method that comprises the digital printing system to use inkjet printing featuring multiple print heads or print cartridges that deposit ink onto paper flat bottom bags. It is an object of the present invention that the deposited ink on the paper flat bottom bags forms an image, images or text. It is an object of the present invention for the method that comprises the digital printing system to use inkjet printing featuring print heads or print cartridges that deposit ink onto paper flat bottom bags to form an image, images or text by forcing ink through a nozzle or similar device. It is an object of the present invention for the method that comprises the digital printing system to use inkjet printing featuring drop-on-demand print heads such as thermal print heads and non-thermal print heads to deposit ink onto paper flat bottom bags to form an image, images or text. It is an-object of the present invention for the method that comprises the digital printing system to use inkjet printing featuring print heads such as thermal print heads and non-thermal print heads to deposit ink onto paper flat bottom bags to form an image, images or text. It is an object of the present invention for the method that comprises the digital printing system to use inkjet printing featuring a combination of different types of print heads such as thermal print heads and non-thermal print heads to deposit ink onto paper flat bottom bags to form an image, images or text.

It is an object of the present invention for the method that comprises the digital printing system to use inkjet printing featuring a single print head or print cartridge that deposits ink onto unprinted paper flat bottom bags. It is an object of the present invention that the deposited ink on the unprinted paper flat bottom bags forms an image, images or text. It is an object of the present invention for the method that comprises the digital printing system to use inkjet printing featuring multiple print heads or print cartridges that deposit ink onto unprinted paper flat bottom bags. It is an object of the present invention that the deposited ink on the unprinted paper flat bottom bags form an image, images or text. It is an object of the present invention for the method that comprises the digital printing system to use inkjet printing featuring print heads or print cartridges that deposit ink onto unprinted paper fiat bottom bags to form an image, images or text by forcing ink through a nozzle or similar device. It is an object of the present invention for the method that comprises the digital printing system to use inkjet printing featuring drop-on-demand print heads such as thermal print heads and non-thermal print heads to deposit ink on unprinted paper flat bottom bags to form an image, images or text. It is an object of the present invention for the method that comprises the digital printing system to use inkjet printing featuring print heads such as thermal print heads and non-thermal print heads to deposit ink onto unprinted paper flat bottom bags to form an image, images or text. It is an object of the present invention for the method that comprises the digital printing system to use inkjet printing featuring a combination of different types of print heads such as thermal print heads and non-thermal print heads to deposit ink onto unprinted paper flat bottom bags to form an image, images or text.

It is an object of the present invention for the method that comprises the digital printing system to use inkjet printing featuring a single print head or print cartridge that deposit inks onto preprinted paper flat bottom bags. It is an object of the present invention that the deposited ink on the preprinted paper flat bottom bags forms an image, images or text other than what is already preprinted on the bags. It is an object of the present invention for the method that comprises the digital printing system to use inkjet printing featuring multiple print heads or print cartridges that deposit ink onto preprinted paper flat bottom bags. It is an object of the present invention that the deposited ink on the preprinted paper flat bottom bags forms an image, images or text other than what is already preprinted on the bags. It is an object of the present invention for the method that comprises the digital printing system to use inkjet printing featuring print heads or print cartridges that deposit ink onto preprinted paper flat bottom bags to form image, images or text other than what is already preprinted on the bags by forcing ink through a nozzle or similar device. It is an object of the present invention for the method that comprises the digital printing system to use inkjet printing featuring drop-on-demand print heads such as thermal print heads and non-thermal print heads to deposit ink on preprinted paper flat bottom bags to form an image, images or text other than what is already preprinted on the bags. It is an object of the present invention for the method that comprises the digital printing system to use inkjet printing featuring print heads such as thermal print heads and non-thermal print heads to deposit ink onto preprinted paper flat bottom bags to form an image, images or text other than what is already preprinted on the bags. It is an object of the present invention for the method that comprises the digital printing system to use inkjet printing featuring a combination of different types of print heads such as thermal print heads and non-thermal print heads to deposit ink onto preprinted paper flat bottom bags to form an image, images or text other than what is already preprinted on the bags.

The present invention relates to a method that comprises the digital printing system to use inkjet printing featuring a single print head or print cartridge controlled by a computer system. It is an object of the present invention for the method that comprises the digital printing system to use inkjet printing featuring multiple print heads or cartridges controlled by a computer system. It is an object of the present invention for the method that comprises the digital printing system for the computer system to direct the movement of each print head or print cartridge across a paper bag to create a printed image, images or text. It is an object of the present invention for the method that comprises the digital printing system for the computer system to direct the movement of each print head or print cartridge across a paper pinch bottom bag to create a printed image, images or text. It is an object of the present invention for the method that comprises the digital printing system for the computer system to direct the movement of each print head or print cartridge across a paper flat bottom bag to create a printed image, images or text.

It is an object of the present invention for the method that comprises the digital printing system to use inkjet printing featuring thermal print heads to deposit ink onto paper pinch bottom bags. It is an object of the present invention to deposit the ink onto paper pinch bottom bags to form an image, images, or text. It is an object of the present invention for the method that comprises the digital printing system to use inkjet printing featuring thermal print heads comprised of single or multiple jetting arrays to deposit ink onto paper pinch bottom bags. It is an object of the present invention for the method that comprises the digital printing system to use inkjet printing featuring thermal print heads to deposit aquas or water-based ink onto paper pinch bottom bags. It is an object of the present invention for the method that comprises the digital printing system to use inkjet printing featuring thermal print heads to deposit up to four colors of ink onto paper pinch bottom bags. It is an object of the present invention for the up to four colors to comprise some combination of black, cyan, magenta, and yellow inks. It is an object of the present invention for the method that comprises the digital printing system to use inkjet printing featuring thermal print heads to deposit one to twelve colors of ink onto paper pinch. bottom bags.

It is an object of the present invention for the method that comprises the digital printing system to use inkjet printing featuring thermal print heads to deposit ink onto unprinted paper pinch bottom bags. It is an object of the present invention to deposit the ink onto unprinted paper pinch bottom bags to form an image, images, or text. It is an object of the present invention for the method that comprises the digital printing system to use inkjet printing featuring thermal print heads comprised of single or multiple jetting arrays to deposit ink onto unprinted paper pinch bottom bags. It is an object of the present invention for the method that comprises the digital printing system to use inkjet printing featuring thermal print heads to deposit aquas or water-based ink onto unprinted paper pinch bottom bags. It is an object of the present invention for the method that comprises the digital printing system to use inkjet printing featuring thermal print heads to deposit up to four colors of ink onto unprinted paper pinch bottom bags. It is an object of the present invention for the up to four colors to comprise some combination of black, cyan, magenta, and yellow inks. It is an object of the present invention for the method that comprises the digital printing system to use inkjet printing featuring thermal print heads to deposit one to twelve colors of ink onto unprinted paper pinch bottom bags.

It is an object of the present invention for the method that comprises the digital printing system to use inkjet printing featuring thermal print heads to deposit ink onto preprinted paper pinch bottom bags. It is an object of the present invention to deposit the ink onto preprinted paper pinch bottom bags to form an image, images, or text. It is an object of the present invention for the method that comprises the digital printing system to use inkjet printing featuring thermal print heads comprised of single or multiple jetting arrays to deposit ink onto preprinted paper pinch bottom bags. It is an object of the present invention for the method that comprises the digital printing system to use inkjet printing featuring thermal print heads to deposit aquas or water-based ink onto preprinted paper pinch bottom bags. It is an object of the present invention for the method that comprises the digital printing system to use inkjet printing featuring thermal print heads to deposit up to four colors of ink onto preprinted paper pinch bottom bags. It is an object of the present invention for the up to four colors to comprise some combination of black, cyan, magenta, and yellow inks. It is an object of the present invention for the method that comprises the digital printing system to use inkjet printing featuring thermal print heads to deposit one to twelve colors of ink onto preprinted paper pinch bottom bags.

It is an object of the present invention for the method that comprises the digital printing system to use inkjet printing featuring thermal print heads to deposit ink onto paper flat bottom bags. It is an object of the present invention to deposit the ink onto paper flat bottom bags to form an image, images, or text. It is an object of the present invention for the method that comprises the digital printing system to use inkjet printing featuring thermal print heads comprised of single or multiple jetting arrays to deposit ink onto paper flat bottom bags. It is an object of the present invention for the method that comprises the digital printing system to use inkjet printing featuring thermal print heads to deposit aquas or water-based ink onto paper flat bottom bags. It is an object of the present invention for the method that comprises the digital printing system to use inkjet printing featuring thermal print heads to deposit up to four colors of ink onto paper flat bottom bags. It is an object of the present invention for the up to four colors comprising some combination of black, cyan, magenta, and yellow inks. It is an object of the present invention for the method that comprises the digital printing system to use inkjet printing featuring thermal print heads to deposit one to twelve colors of ink onto paper pinch bottom bags.

It is an object of the present invention for the method that comprises the digital printing system to use inkjet printing featuring thermal print heads to deposit ink onto unprinted paper flat bottom bags. It is an object of the present invention to deposit the ink onto unprinted paper flat bottom bags to form an image, images, or text. It is an object of the present invention for the method that comprises the digital printing system to use inkjet printing featuring thermal print heads comprised of single or multiple jetting arrays to deposit ink onto unprinted paper flat bottom bags. It is an object of the present invention for the method that comprises the digital printing system to use inkjet printing featuring thermal print heads to deposit aquas or water-based ink onto unprinted paper flat bottom bags. It is an object of the present invention for the method that comprises the digital printing system to use inkjet printing featuring thermal print heads to deposit up to four colors of ink onto unprinted paper flat bottom bags. It is an object of the present invention for the up to four colors to comprise some combination of black, cyan, magenta, and yellow inks. It is an object of the present invention for the method that comprises the digital printing system to use inkjet printing featuring thermal print heads to deposit one to twelve colors of ink onto unprinted paper flat bottom bags.

It is an object of the present invention for the method that comprises the digital printing system to use inkjet printing featuring thermal print heads to deposit ink onto preprinted paper flat bottom bags. It is an object of the present invention to deposit the ink onto preprinted paper flat bottom bags to form an image, images, or text. It is an object of the present invention for the method that comprises the digital printing system to use inkjet printing featuring thermal print heads comprised of single or multiple jetting arrays to deposit ink onto preprinted paper flat bottom bags. It is an object of the present invention for the method that comprises the digital printing system to use inkjet printing featuring thermal print heads to deposit aquas or water-based ink onto preprinted paper flat bottom bags. It is an object of the present invention for the method that comprises the digital printing system to use inkjet printing featuring thermal print heads to deposit up to four colors of ink onto preprinted paper at bottom bags. It is an object of the present invention for the up to four colors to comprise some combination of black, cyan, magenta, and yellow inks. It is an object of the present invention for the method that comprises the digital printing system to use inkjet printing featuring thermal print heads to deposit one to twelve colors of ink onto preprinted paper flat bottom bags.

It is an object of the present invention for the method that comprises the digital printing system to use inkjet printing featuring non-thermal print heads such as ones using piezoelectricity called Piezo print heads to deposit ink onto paper pinch bottom bags. It is an object of the present invention to deposit the ink onto paper pinch bottom bags to form an image, images, or text. It is an object of the present invention for the method that comprises the digital printing system to use inkjet printing featuring non-thermal print heads such as ones using Piezo print heads comprised of single or multiple jetting arrays to deposit ink onto paper pinch bottom bags. It is an object of the present invention for the method that comprises the digital printing system to use inkjet printing featuring non-thermal print heads such as Piezo print heads to deposit compatible inks such as water-based inks, oil-based inks, eco-solvent based inks and solvent based inks onto paper pinch bottom bags.

It is an object of the present invention for the method that comprises the digital printing system to use inkjet printing featuring Piezo print heads to control the size of the ink droplet or droplets deposited onto paper pinch bottom bags. It is an object of the present invention for the method that comprises the digital printing system to use inkjet printing featuring Piezo print heads to control the size of the ink droplet or droplets to increase print resolution. It is an object of the present invention for the method that comprises the digital printing system to use inkjet printing featuring Piezo print heads to print up to 5,000 dots per inch of ink onto paper pinch bottom bags measured on a vertical or widthwise basis. It is an object of the present invention for the method that comprises the digital printing system to use inkjet printing featuring Piezo print heads to print up to 6,000 dots per inch of ink onto paper pinch bottom bags measured on a vertical or widthwise basis. It is an object of the present invention for the method that comprises the digital printing system to use inkjet printing featuring Piezo print heads to print 300, 600, 900, or 1,200 dots per inch of ink onto paper pinch bottom bags measured on a vertical or widthwise basis. It is an object of the present invention for the method that comprises the digital printing system to use inkjet printing featuring Piezo print heads to print up to 1,200 dots per inch of ink onto paper pinch bottom paper bags measured on a vertical or widthwise basis. It is an object of the present invention for the method that comprises the digital printing system to use inkjet printing featuring Piezo print heads to print up to 2,400 dots per inch of ink onto paper pinch bottom paper bags measured on a vertical or widthwise basis. It is an object of the present invention for the method that comprises the digital printing system to use inkjet printing featuring Piezo print heads to approach photo quality printing by printing up to 5,000 dots per inch of ink onto paper pinch bottom bags. It is an object of the present invention for the method that comprises the digital printing system to use inkjet printing featuring Piezo print heads to achieve photo quality printing by printing up to 6,000 dots per inch of ink onto paper pinch bottom bags.

The present invention relates to a method that comprises using a digital printing system for inkjet printing featuring Piezo print heads that print dots per inches of ink measured on both a vertical and horizontal basis on paper pinch bottom bags. It is an object of the present invention for the method that comprises the digital printing system to use inkjet printing featuring Piezo print heads to print up to 5,000 dots per inch of ink measured on a vertical or widthwise basis on paper pinch bottom bags. It is an object of the present invention for the method that comprises the digital printing system to use inkjet printing featuring Piezo print heads to print up to 5,000 dots per inch of ink measured on a horizontal or lengthwise basis on paper pinch bottom bags. It is an object of the present invention for the method that comprises the digital printing system to use inkjet printing featuring Piezo print heads to print up to 5,000 dots per inch of ink measured in both a vertical and horizontal basis on paper pinch bottom bags. It is an object of the present invention for the method that comprises the digital printing system to use inkjet printing featuring Piezo print heads to print up to 6,000 dots per inch of ink measured on a vertical or widthwise basis on paper pinch bottom bags. It. Is an object of the present invention for the method that comprises the digital printing system to use inkjet printing featuring Piezo print heads to print up to 6,000 dots per inch of ink measured on a horizontal or lengthwise basis on paper pinch bottom bags. It is an object of the present invention for the method that comprises the digital printing system to use inkjet printing featuring Piezo print heads to print up to 6,000 dots per inch of ink measured on both a vertical and horizontal basis on paper pinch bottom bags. It is an object of the present invention for the method that comprises the digital printing system to use inkjet printing featuring Piezo print heads to print vertical dots per inch of ink equal to the horizontal dots per inch of ink on the same paper pinch bottom bags. It is an object of the present invention for the method that comprises the digital printing system to use inkjet printing featuring Piezo print heads to print vertical dots per inch of ink different in quantity from the horizontal dots per inch of ink on the same paper pinch bottom bags.

It is an object of the present invention for the method that comprises the digital printing system to use inkjet printing featuring non-thermal print heads such as ones using piezoelectricity to deposit ink onto unprinted paper pinch bottom bags. It is an object of the present invention to deposit the ink onto unprinted paper pinch bottom bags to form an image, images or text it is an object of the present invention for the method that comprises the digital printing system to use inkjet printing featuring non-thermal print heads such as ones using piezoelectricity comprised of single or multiple jetting arrays to deposit ink onto unprinted paper pinch bottom bags. It is an object of the present invention for the method that comprises the digital printing, system to use inkjet printing featuring non-thermal print heads such as Piezo print heads to deposit compatible inks such as water-based inks, oil-based inks, eco-solvent based inks and solvent based inks onto unprinted paper pinch bottom bags.

It is an object of the present invention for the method that comprises the digital printing system to use inkjet printing featuring Piezo print heads to control the size of the ink droplet or droplets deposited onto unprinted paper pinch bottom bags. It is an object of the present invention for the method that comprises the digital printing system to use inkjet printing featuring Piezo print heads to control the size of the ink droplet or droplets to increase print resolution. It is an object of the present invention for the method that comprises the digital printing system to use inkjet printing featuring Piezo print heads to print up to 5,000 dots per inch of ink onto unprinted paper pinch bottom bags measured on a vertical or widthwise basis. It is an object of the present invention for the method that comprises the digital printing system to use inkjet printing featuring Piezo print heads to print up to 6,000 dots per inch of ink onto unprinted paper pinch bottom bags measured on a vertical or widthwise basis. It is an object of the present invention for the method that comprises the digital printing system to use inkjet printing featuring Piezo print heads to print 300, 600, 900 or 1,200 dots per inch of ink onto unprinted paper pinch bottom bags measured on a vertical or widthwise basis. It is an object of the present invention for the method that comprises the digital printing system to use inkjet printing featuring Piezo print heads to print up to 1,200 dots per inch of ink onto unprinted paper pinch bottom bags measured on a vertical or widthwise basis. It is an object of the present invention for the method that comprises the digital printing system to use inkjet printing featuring Piezo print heads to print up to 2,400 dots per inch of ink onto unprinted paper pinch bottom bags measured on a vertical or widthwise basis. It is an object of the present invention for the method that comprises the digital printing system to use inkjet printing featuring Piezo print heads to approach photo quality printing by printing up to 5,000 dots per inch of ink onto imprinted paper pinch bottom bags. It is an object of the present invention for the method that comprises the digital printing system to use inkjet printing featuring Piezo print heads to achieve photo quality printing by printing up to 6,000 dots per inch of ink onto unprinted paper pinch bottom bags.

The present invention relates to a method that comprises using a digital printing system for inkjet printing featuring Piezo print heads that print dots per inches of ink measured on both a vertical and horizontal basis on unprinted paper pinch bottom bags. It is an object of the present invention for the method that comprises the digital printing system to use inkjet printing featuring Piezo print heads to print up to 5,000 dots per inch of ink measured on a vertical or widthwise basis on imprinted paper pinch bottom bags. It is an object of the present invention for the method that comprises the digital printing system to use inkjet printing featuring Piezo print heads to print up to 5,000 dots per inch of ink measured on a horizontal or lengthwise basis on Imprinted paper pinch bottom bags. It is an object of the present invention for the method that comprises the digital printing system to use inkjet printing featuring Piezo print heads to print up to 5,000 dots per inch of ink measured on both a vertical and horizontal basis on imprinted paper pinch bottom bags. It is an object of the present invention for the method that comprises the digital printing system to use inkjet printing featuring Piezo print heads to print up to 6,000 dots per inch of ink measured on a vertical or widthwise basis on unprinted paper pinch bottom bags. It is an object of the present invention for the method that comprises the digital printing system to use inkjet printing featuring Piezo print heads to print up to 6,000 dots per inch of ink measured on a horizontal or lengthwise basis on unprinted paper pinch bottom bags. It is an object of the present invention for the method that comprises the digital printing system to use inkjet printing featuring Piezo print heads to print up to 6,000 dots per inch of ink measured on both a vertical and horizontal basis on unprinted paper pinch bottom bags it is an object of the present invention for the method that comprises the digital printing system to use inkjet printing featuring Piezo print heads to print vertical dots per inch of ink equal to the horizontal dots per inch of ink on the same imprinted paper pinch bottom bags. It is an object of the present invention for the method that comprises the digital priming system to use inkjet printing featuring Piezo print heads to print vertical dots per inch of ink different in quantity from the horizontal dots per inch of ink on the same unprinted paper pinch bottom bags.

It is an object of the present invention for the method that comprises the digital printing system to use inkjet printing featuring non-thermal print heads such as ones using piezoelectricity to deposit ink onto preprinted paper pinch bottom bags. It is an object of the present invention for the method that comprises the digital printing system to use inkjet printing featuring non-thermal print heads such as ones using piezoelectricity comprised of single or multiple jetting arrays to deposit ink onto preprinted paper pinch bottom bags. It is an object of the present invention for the method that comprises the digital printing system to use inkjet printing featuring non-thermal print heads such as Piezo print heads to deposit compatible inks such as water-based inks, oil-based inks, eco-solvent based inks and solvent based inks onto preprinted paper pinch bottom bags. It is an object of the present invention for the method that comprises the digital printing system to use inkjet printing featuring Piezo print heads to deposit ink onto a preprinted paper pinch bottom bag to form an image, images or text other than what is already preprinted on the bag.

It is an object of the present invention for the method that comprises the digital printing system to use inkjet printing featuring Piezo print heads to control the size of the ink droplet or droplets deposited onto preprinted paper pinch bottom bags. It is an object of the present invention for the method that comprises the digital printing system to use inkjet printing featuring Piezo print heads to control the size of the ink droplet or droplets to increase print resolution. It is an object of the present invention for the method that comprises the digital printing system to use inkjet printing featuring Piezo print heads to print up to 5,000 dots per inch of ink onto preprinted paper pinch bottom bags measured on a vertical or widthwise basis. It is an object of the present invention for the method that comprises the digital printing system to use inkjet printing featuring Piezo print heads to print up to 6,000 dots per inch of ink onto preprinted paper pinch bottom bags measured on a vertical or widthwise basis. It is an object of the present invention for the method that comprises the digital printing system to use inkjet printing featuring Piezo print heads to print 300, 600, 900 or 1,200 dots per inch of ink onto preprinted paper pinch bottom bags measured on a vertical or widthwise basis. It is an object of the present invention for the method that comprises the digital printing system to use inkjet printing featuring Piezo print heads to print up to 1,200 dots per inch of ink onto preprinted paper pinch bottom bags measured on a vertical or widthwise basis. It is an object of the present invention for the method that comprises the digital printing system to use inkjet printing featuring Piezo print heads to print up to 2,400 dots per inch of ink onto preprinted paper pinch bottom bags measured on a vertical or widthwise basis. It is an object of the present invention for the method that comprises the digital printing system to use inkjet printing featuring Piezo print heads to approach photo quality printing by printing up to 5,000 dots per inch of ink onto preprinted paper pinch bottom bags. It is an object of the present invention for the method that comprises the digital printing system to use inkjet printing featuring Piezo print heads to achieve photo quality printing by printing up to 6,000 dots per inch of ink onto preprinted paper pinch. bottom bags.

The present invention relates to a method that comprises using a digital printing system for inkjet printing featuring Piezo print heads that print dots per inches of ink measured on both a vertical and horizontal basis on preprinted paper pinch bottom bags. It is an object of the present invention for the method that comprises the digital printing system to use inkjet printing featuring Piezo print heads to print up to 5,000 dots per inch of ink measured on a vertical or widthwise basis on preprinted paper pinch bottom bags. It is an object of the present invention for the method that comprises the digital printing system to use inkjet printing featuring Piezo print heads to print up to 5,000 dots per inch of ink measured on a horizontal or lengthwise basis on preprinted paper pinch bottom bags. It is an object of the present invention for the method that comprises the digital printing system to use inkjet printing featuring Piezo print heads to print up to 5,000 dots per inch of ink measured on both a vertical and horizontal basis on. preprinted paper pinch bottom bags. It is an object of the present invention for the method that comprises the digital priming system to use inkjet printing featuring Piezo print heads to print up to 6,000 dots per inch of ink measured on a vertical or widthwise basis on preprinted paper pinch bottom bags. It is an object of the present invention for the method that comprises the digital printing system to use inkjet printing featuring Piezo print heads to print up to 6,000 dots per inch of ink measured on a horizontal or lengthwise basis on preprinted paper pinch bottom bags. It is an object of the present invention for the method that comprises the digital printing system to use inkjet printing featuring Piezo print heads to print up to 6,000 dots per inch of ink measured on both a vertical and horizontal basis on preprinted paper pinch bottom bags. It is an object of the present invention for the method that comprises the digital printing system to use inkjet printing featuring Piezo print heads to print vertical dots per inch of ink equal to the horizontal dots per inch of ink on the same preprinted paper pinch bottom bags. It is an object of the present invention for the method that comprises the digital printing system to use inkjet printing featuring Piezo print heads to print vertical dots per inch of ink different in quantity from the horizontal dots per inch of ink on the same preprinted paper pinch bottom bags,

It is an object of the present invention for the method that comprises the digital printing system to use inkjet printing featuring non-thermal print heads such as ones using piezoelectricity to deposit ink onto paper flat bottom bags. It is an object of the present invention to deposit the ink onto paper fiat bottom bags to form an image, images or text. It is an object of the present invention for the method that comprises the digital printing system to use inkjet printing featuring non-thermal print heads such as ones using Piezo print heads comprised of single or multiple jetting arrays to deposit ink onto paper flat bottom bags. It is an object of the present invention for the method that comprises the digital printing system to use inkjet printing featuring non-thermal print heads such as Piezo print heads to deposit compatible inks such as water-based inks, oil-based inks, eco-solvent based inks and solvent based inks onto paper flat bottom bags.

It is an object of the present invention for the method that comprises the digital printing system to use inkjet printing featuring Piezo print heads to control the size of the ink droplet or droplets deposited onto paper flat bottom bags. It is an object of the present invention for the method that comprises the digital printing system to use inkjet printing featuring Piezo print heads to control the size of the ink droplet or droplets to increase print resolution. It is an object of the present invention for the method that comprises the digital printing system to use inkjet printing featuring Piezo print heads to print up to 5,000 dots per inch of ink onto paper flat bottom bags measured on a vertical or widthwise basis. It is an object of the present invention for the method that comprises the digital printing system to use inkjet printing featuring Piezo print heads to print up to 6,000 dots per inch of ink onto paper flat bottom bags measured on a vertical or widthwise basis. It is an object of the present invention for the method that comprises the digital printing system to use inkjet printing featuring Piezo print heads to print 300, 600, 900 or 1,200 dots per inch of ink onto paper flat bottom bags measured on a vertical or widthwise basis. It is an object of the present invention for the method that comprises the digital printing system to use inkjet printing featuring Piezo print heads to print up to 1,200 dots per inch of ink onto paper flat bottom bags on a vertical or widthwise basis. It is an object of the present invention for the method that comprises the digital printing system to use inkjet printing featuring Piezo print heads to print up to 2,400 dots per inch of ink onto paper flat bottom bags measured on a vertical or widthwise basis. It is an object of the present invention for the method that comprises the digital printing system to use inkjet printing featuring Piezo print heads to approach photo quality printing by printing up to 5,000 dots per inch of ink onto paper flat bottom bags. It is an object of the present invention for the method that comprises the digital printing system to use inkjet printing featuring Piezo print heads to achieve photo quality printing by printing up to 6,000 dots per inch of ink onto paper flat bottom bags.

The present invention relates to a method that comprises using a digital printing system for inkjet printing featuring Piezo print heads that print dots per inches of ink measured on both a vertical and horizontal basis on paper flat bottom bags. It is an object of the present invention for the method that comprises the digital printing system to use inkjet printing featuring Piezo print heads to print up to 5,000 dots per inch of ink measured on a vertical or widthwise basis on paper flat bottom bags. It is an object of the present invention for the method that comprises the digital printing system to use inkjet printing featuring Piezo print heads to print up to 5,000 dots per inch of ink measured on a horizontal or lengthwise basis on paper flat bottom bags. It is an object of the present invention for the method that comprises the digital printing system to use inkjet printing featuring Piezo print heads to print up to 5,000 dots per inch of ink measured on both a vertical and horizontal basis on paper flat bottom bags. It is an object of the present invention for the method that comprises the digital printing system to use inkjet printing featuring Piezo print heads to print up to 6,000 dots per inch of ink measured on a vertical or widthwise basis on paper flat bottom bags. It is an object of the present invention for the method that comprises the digital printing system to use inkjet printing featuring Piezo print heads to print up to 6,000 dots per inch of ink measured on a horizontal or lengthwise basis on paper flat bottom bags. It is an object of the present invention for the method that comprises the digital printing system to use inkjet printing featuring Piezo print heads to print up to 6,000 dots per inch of ink measured on both a vertical and horizontal basis on paper flat bottom bags. It is an object of the present invention for the method that comprises the digital printing system to use inkjet printing featuring Piezo print heads to print vertical dots per inch of ink equal to the horizontal dots per inch of ink on the same paper flat bottom bags. It is an object of the present invention for the method that comprises the digital printing system to use inkjet printing featuring Piezo print heads to print vertical dots per inch of ink different in quantity from the horizontal dots per inch of ink on the same paper fiat bottom bags.

It is an object of the present invention for the method that comprises the digital printing system to use inkjet printing featuring non-thermal print heads such as ones using piezoelectricity to deposit ink onto unprinted paper flat bottom bags. It is an object of the present invention to deposit the ink onto unprinted paper flat bottom bags to form an image, images or text. It is an object of the present invention for the method that comprises the digital printing system to use inkjet printing featuring non-thermal print heads such as ones using Piezo print heads comprised of single or multiple jetting arrays to deposit ink onto unprinted paper flat bottom bags. It is an object of the present invention for the method that comprises the digital printing system to use inkjet printing featuring non-thermal print heads such as Piezo print heads to deposit compatible inks such as water-based inks, oil-based inks, eco-solvent based inks and solvent based inks onto unprinted paper flat bottom bags.

It is an object of the present invention for the method that comprises the digital printing system to use inkjet printing featuring Piezo print heads to control the size of the ink droplet or droplets deposited onto unprinted paper flat bottom bags. It is an object of the present invention for the method that comprises the digital printing system to use inkjet printing featuring Piezo print heads to control the size of the ink droplet or droplets to increase print resolution. It is an object of the present invention for the method that comprises the digital printing system to use inkjet printing featuring Piezo print heads to print up to 5,000 dots per inch of ink onto unprinted flat bottom paper bags measured on a vertical or widthwise basis. It is an object of the present invention for the method that comprises the digital printing system to use inkjet printing featuring Piezo print heads to print up to 6,000 dots per inch of ink onto unprinted paper flat bottom bags measured on a vertical or widthwise basis. It is an object of the present invention for the method that comprises the digital printing system to use inkjet printing featuring Piezo print heads to print 300, 600, 900 or, 1,200 dots per inch of ink onto unprinted flat bottom paper bags measured on a vertical or widthwise basis. It is an object of the present invention for the method that comprises the digital printing system to use inkjet printing featuring Piezo print heads to print up to 1,200 dots per inch of ink onto unprinted paper flat bottom bags measured on a vertical or widthwise basis. It is an object of the present invention for the method that comprises the digital printing system to use inkjet printing featuring Piezo print heads to print up to 2,400 dots per inch of ink onto unprinted paper flat bottom bags measured on a vertical or widthwise basis. It is an object of the present invention for the method that comprises the digital printing system to use inkjet printing featuring Piezo print heads to approach photo quality printing, by printing up to 5,000 dots per inch of ink onto unprinted paper flat bottom bags. It is an object of the present invention for the method that comprises the digital printing system to use inkjet printing featuring Piezo print heads to achieve photo quality printing by printing up to 6,000 dots per inch of ink onto unprinted paper flat bottom bags.

The present invention relates to a method that comprises using a digital printing system for inkjet printing featuring Piezo print heads that print dots per inches of ink measured on both a vertical and horizontal basis on unprinted paper flat bottom bags. It is an object of the present invention for the method that comprises the digital printing system to use inkjet printing featuring Piezo print heads to print up to 5,000 dots per inch of ink measured on a vertical or widthwise basis on unprinted paper flat bottom bags. It is an object of the present invention for the method that comprises the digital printing system to use inkjet printing featuring Piezo print heads to print up to 5,000 dots per inch of ink measured on a horizontal or length wise basis on imprinted paper flat bottom bags. It is an object of the present invention for the method that comprises the digital printing system to use inkjet printing featuring Piezo print heads to print up to 5,000 dots per inch of ink measured on both a vertical and horizontal basis on imprinted paper flat bottom bags. It is an object of the present invention for the method that comprises the digital printing system to use inkjet printing featuring Piezo print heads to print up to 6,000 dots per inch of ink measured on a vertical or widthwise basis on unprinted paper flat bottom bags. It is an object of the present invention for the method that comprises the digital printing system to use inkjet printing featuring Piezo print heads to print up to 6,000 dots per inch of ink measured on a horizontal or lengthwise basis on unprinted paper flat bottom bags. It is an object of the present invention for the method that comprises the digital printing system to use inkjet printing featuring Piezo print heads to print up to 6,000 dots per inch of ink measured on both a vertical and horizontal basis on unprinted paper flat bottom bags. It is an object of the present invention for the method that comprises the digital printing system to use inkjet printing featuring Piezo print heads to print vertical dots per inch of ink equal to the horizontal dots per inch of ink on the same unprinted paper flat bottom bags. It is an object of the present invention for the method that comprises the digital printing system to use inkjet printing featuring Piezo print heads to print vertical dots per inch of ink different in quantity from the horizontal dots per inch of ink on the same unprinted paper flat bottom bags.

It is an object of the present invention for the method that comprises the digital printing system to use inkjet printing featuring non-thermal print heads such as ones using piezoelectricity to deposit ink onto preprinted paper fiat bottom bags. It is an object of the present invention for the method that comprises the digital printing system to use inkjet printing featuring non-thermal print heads such as ones using Piezo print heads comprised of single or multiple jetting arrays to deposit ink onto preprinted paper fiat bottom bags. It is an object of the present invention for the method that comprises the digital printing system to use inkjet printing featuring non-thermal print heads such as Piezo print heads to deposit compatible inks such as water-based inks, oil-based inks, eco-solvent based inks and solvent based inks onto preprinted paper flat bottom bags. It is an object of the present invention for the method that comprises the digital printing system to use inkjet printing featuring Piezo print heads to deposit ink onto a preprinted paper flat bottom bag to form an image, images or text other than what is already preprinted on the bag.

It is an object of the present invention for the method that comprises the digital printing system to use inkjet printing featuring. Piezo print heads to control the size of the ink droplet or droplets deposited onto preprinted paper flat bottom bags. It is an object of the present invention for the method that comprises the digital printing system to use inkjet printing featuring Piezo print heads to control the size of the ink droplet or droplets to increase print resolution. It is an object of the present invention for the method that comprises the digital printing system to use inkjet printing featuring Piezo print heads to print up to 5,000 dots per inch of ink onto preprinted flat bottom paper bags measured on a vertical or widthwise basis. It is an object of the present invention for the method that comprises the digital printing system to use inkjet printing featuring Piezo print heads to print up to 6,000 dots per inch of ink onto preprinted flat bottom paper bags measured on a vertical or widthwise basis. It is an object of the present invention for the method that comprises the digital printing system to use inkjet printing featuring Piezo print heads to print 300, 600, 900 or 1,200 dots per inch of ink onto preprinted flat bottom paper bags measured on a vertical or widthwise basis. It is an object of the present invention for the method that comprises the digital printing system to use inkjet printing featuring Piezo print heads to print up to 1,200 dots per inch of ink onto preprinted flat bottom paper bags measured on a vertical or widthwise basis. It is an object of the present invention for the method that comprises the digital printing system to use inkjet printing featuring Piezo print heads to print up to 2,400 dots per inch of ink onto preprinted flat bottom paper bags measured on a vertical or widthwise basis. It is an object of the present invention for the method that comprises the digital printing system to use inkjet printing featuring Piezo print heads to approach photo quality printing by printing up to 5,000 dots per inch of ink onto preprinted flat bottom paper bags. It is an object of the present invention for the method that comprises the digital printing system to use inkjet printing featuring Piezo print heads to achieve photo quality printing by printing up to 6,000 dots per inch of ink onto preprinted flat bottom paper bags.

The present invention relates to a method that comprises using a digital printing system for inkjet printing featuring Piezo print heads that print dots per inches of ink measured on both a vertical and horizontal basis on preprinted paper flat bottom bags. It is an object of the present invention for the method that comprises the digital printing system to use inkjet printing featuring Piezo print heads to print up to 5,000 dots per inch of ink measured on a vertical or widthwise basis on preprinted paper flat bottom bags. It is an object of the present invention for the method that comprises the digital printing system to use inkjet printing featuring Piezo print heads to print up to 5,000 dots per inch of ink measured on a horizontal or lengthwise basis on preprinted paper flat bottom bags. It is an object of the present invention for the method that comprises the digital printing system to use inkjet printing featuring Piezo print heads to print up to 5,000 dots per inch of ink measured on both a vertical and horizontal basis on preprinted paper flat bottom bags. It is an object of the present invention for the method that comprises the digital printing system to use inkjet printing featuring Piezo print heads to print up to 6,000 dots per inch of ink measured on a vertical or widthwise basis on preprinted paper flat bottom bags. It is an object of the present invention for the method that comprises the digital printing system to use inkjet printing featuring Piezo print heads to print up to 6,000 dots per inch of ink measured on a horizontal or lengthwise basis on preprinted paper flat bottom bags. It is an object of the present invention for the method that comprises the digital printing system to use inkjet printing featuring Piezo print heads to print up to 6,000 dots per inch of ink measured on both a vertical and horizontal basis on preprinted paper flat bottom bags. It is an object of the present invention for the method that comprises the digital printing system to use inkjet printing featuring Piezo print heads to print vertical dots per inch of ink equal to the horizontal dots per inch of ink on the same preprinted paper flat bottom bags. It is an object of the present invention for the method that comprises the digital printing system to use inkjet printing featuring Piezo print heads to print vertical dots per inch of ink different in quantity from the horizontal dots per inch of ink on the same preprinted paper flat bottom bags.

It is an object of the present invention for the method that comprises the digital printing system to use inkjet printing featuring Piezo print heads to print cyan, magenta, yellow and black images or CMYK images or text using UV curable inks on paper bags. It is an object of the present invention for the method that comprises the digital printing system to use inkjet printing featuring Piezo print heads to print cyan, magenta, yellow and black images or CMYK images or text using UV curable inks on paper pinch bottom bags. It is an object of the present invention for the method that comprises the digital printing system to use inkjet printing featuring Piezo print heads to print cyan, magenta, yellow and black images or CMYK images or text using UV curable inks on paper flat bottom bags.

It is an object of the present invention for the method that comprises the digital printing system to use inkjet printing featuring Piezo print heads to yield a vertical print capacity or printing width on paper bags ranging from 0.25 inches to 6 inches. It is an object of the present invention for the method that comprises the digital printing system to use inkjet printing featuring Piezo print heads to yield a vertical print capacity or printing width on paper pinch bottom bags ranging from 0.25 inches to 6 inches It is an object of the present invention for the method that comprises the digital printing system to use inkjet printing featuring Piezo print heads to yield a vertical print capacity or printing width on paper flat bottom bags ranging from 0.25 inches to 6 inches. It is an object of the present invention for the method that comprises the digital printing system to use inkjet printing featuring Piezo print heads to yield a vertical print capacity or printing width on paper bags ranging from 0.25 inches to 10 inches. It is an object of the present invention for the method that comprises the digital printing system to use inkjet printing featuring Piezo print heads to yield a vertical print capacity or printing width on paper pinch bottom bags ranging from 0.25 inches to 10 inches. It is an object of the present invention for the method that comprises the digital printing system to use inkjet printing featuring Piezo print heads to yield a vertical print capacity or printing width on paper flat bottom bags ranging from 0.25 inches to 10 inches.

It is an object of the present invention for the method that comprises the digital printing system to use inkjet printing featuring Piezo print heads to yield a vertical print capacity or printing width on unprinted paper bags ranging from 0.25 inches to 6 inches. It is an object of the present invention for the bags to be pinch bottom bags. It is an object of the present invention for the bags to be flat bottom bags. It is an object of the present invention for the method that comprises the digital printing system to use inkjet printing featuring Piezo print heads to yield a vertical print capacity or printing width on unprinted paper bags ranging from 0.25 inches to 10 inches. It is an object of the present invention for the bags to be pinch bottom bags. It is an object of the present invention for the bags to be flat bottom bags.

It is an object of the present invention for the method that comprises the digital printing system to use inkjet printing featuring Piezo print heads to yield a vertical print capacity or printing width on preprinted paper bags ranging from 0.25 inches to 6 inches. It is an object of the present invention for the bags to be pinch bottom bags. It is an object of the present invention for the bags to be flat bottom bags. It is an object of the present invention for the method that comprises the digital printing system to use inkjet printing featuring Piezo print heads to yield a vertical print capacity or printing width on preprinted paper bags ranging from 0.25 inches to 10 inches. It is an object of the present invention for the bags to be pinch bottom bags. It is an object of the present invention for the bags to be flat bottom bags.

The present invention relates to a method that comprises a digital printing system for print heads or print cartridges wherein ink is obtained for printing from integrated inkjet system receptacles such as ink canisters or bottles. It is an object of the present invention for the method that comprises the digital printing system for the jetting arrays in print heads or print cartridges to obtain ink for printing from integrated inkjet system receptacles such as ink canisters or bottles. It is an object of the present invention for the method to comprise using a single color of ink in each inkjet system receptacle such as an ink canister or bottle. It is an object of the present invention for the method to comprise using integrated multiple inkjet system receptacles such as ink canisters or bottles.

The present invention relates to a method that comprises using a digital printing system for inkjet printing that has an integrated feed system for printing paper bags. It is an object of the present invention for the method to comprise stacking paper bags for digital printing in a bag stacker connected to or attached to a conveyor belt or similar transport system. It is an object of the present invention for the method to comprise automatically flowing or moving the paper bags from the bag stacker to a bag feeding system by using a conveyor belt or similar transport system. It is an object of the present invention for the method to comprise automatically flowing or moving one paper bag at a time from the bag feeding system to the bag digital printing system. It is an object of the present invention for the method to comprise using a conveyor belt or similar transport system to automatically flow or move one paper bag at a time from the bag feeding system to the bag digital printing system. It is an object of the present invention for the method to comprise using print heads or print cartridges as part of the digital printing system to deposit ink onto each bag to form an image, images or text. It is an object of the present invention for the digital printing system to comprise electronics including software to control operation of the system, print heads or print cartridges, and ink bottles or ink canisters. It is an object of the present invention for the method to comprise using a conveyor belt or similar transport to automatically flow or move the paper bags from the bag digital printing system to the bag drying system. It is an object of the present invention for the method to comprise using a conveyor belt or similar transport system to automatically flow or move one paper bag at a time from the bag digital printing system to the bag drying system. It is an object of the present invention for the method to comprise using a conveyor belt or similar transport system to automatically flow or move the paper bags from the bag drying system to the bag stacker for printed bags. It is an object of the present invention for the method to comprise using a conveyor belt or similar transport system to automatically flow or move one printed paper bag at a time from the bag drying system to the bag stacker for printed bags. It is an object of the present invention for the method to comprise using alignment guides when moving the paper bags through each system of the digital printing process. It is an object of the present invention for the method to comprise using alignment guides when moving the paper bags through each stage of the digital printing process. It is an object of the present invention for the method to comprise using alignment guides along the conveyor belt or similar transport system when moving the paper bags through each stage of the digital printing process. It is an object of the present invention for the method to comprise automatically flowing previously produced paper bags along a conveyor belt or similar transport system through each stage of the digital printing process.

It is an object of the present invention for the method to comprise using a mobile digital printing unit that is moved to different printers. It is an object of the present invention for the method to comprise using a mobile digital printing unit with an inkjet print head designed to print a single color. It is an object of the present invention for the method to comprise using a mobile digital printing unit with an inkjet print head designed to print multiple colors. It is an object of the present invention for the method to comprise using a mobile digital printing unit with multiple inkjet print heads designed to print multiple colors. It is an object of the present invention for the method to comprise connecting more than one mobile digital printing unit to the digital printing system. It is an object of the present invention for the method to comprise connecting more than one mobile digital printing unit to the digital printing system, so that each mobile digital printing unit can print one ink color. It is an object of the present invention for the method to comprise connecting more than one mobile digital printing unit to the digital printing system, so that each mobile digital printing unit can print multiple ink colors.

The present invention relates to a method that comprises using a digital printing system for inkjet printing that has an integrated feed system for printing unprinted paper bags. It is an object of the present invention for the method to comprise stacking unprinted paper bags for digital printing in a bag stacker connected to or attached to a conveyor belt or similar transport system. It is an object of the present invention for the method to comprise automatically flowing or moving the unprinted paper bags from the bag stacker to a bag feeding system by using a conveyor belt or similar transport system. It is an object of the present invention for the method to comprise automatically flowing or moving one unprinted paper bag at a time from the bag feeding system to the bag digital printing system. It is an object of the present invention for the method to comprise using a conveyor belt or similar transport system to automatically flow or move one unprinted paper bag at a time from the bag feeding system to the bag digital printing system. It is an object of the present invention for the method to comprise using print heads or print cartridges as part of the digital printing system to deposit ink onto each unprinted bag to form an image, images or text. It is an object of the present invention for the method to comprise using a conveyor belt or similar transport to automatically flow or move the printed paper bags from the bag digital printing system to the bag drying system. Is an object of the present invention for the method to comprise using a conveyor belt or similar transport system to automatically flow or move one printed paper bag at a time from the bag digital printing system to the bag drying system. It is an object of the present invention for the method to comprise using a conveyor belt or similar transport system to automatically flow or move the printed paper bags from the bag drying system to the bag stacker for printed bags. It is an object of the present invention for the method to comprise using a conveyor belt or similar transport system to automatically flow or move one printed paper bag at a time from the bag drying system to the bag stacker for printed bags. It is an object of the present invention for the method to comprise using alignment guides when moving the printed paper bags through each system of the digital printing process. It is an object of the present invention for the method to comprise using alignment guides when moving the printed paper bags through each stage of the digital printing process. It is an object of the present invention for the method to comprise using alignment guides along the conveyor belt or similar transport system when moving the unprinted or printed paper bags through each stage of the digital printing process. It is an object of the present invention for the method to comprise automatically flowing previously produced paper bags along a conveyor belt or similar transport system through each stage of the digital printing process.

The present invention relates to a method that comprises using a digital printing system for inkjet printing that has an integrated feed system for printing preprinted paper bags. It is an object of the present invention for the method to comprise stacking preprinted paper bags for digital printing in a bag stacker connected to or attached to a conveyor belt or similar transport system. It is an object of the present invention for the method to comprise automatically flowing or moving the preprinted paper bags from the bag stacker to a bag feeding system by using a conveyor belt or similar transport system. It is an object of the present invention for the method to comprise automatically flowing or moving one preprinted paper bag at a time from the bag feeding system to the bag digital printing system. It is an object of the present invention for the method to comprise using a conveyor belt or similar transport system to automatically flow or move one preprinted paper bag at a time from the bag feeding system to the bag digital printing system. It is an object of the present invention for the method to comprise using print heads or print cartridges as part of the digital printing system to deposit ink onto each preprinted bag to form an additional image, images or text. It is an object of the present invention for the method to comprise using a conveyor belt or similar transport to automatically flow or move the printed paper bags from the bag digital printing system to the bag drying system. It is an object of the present invention for the method to comprise using a conveyor belt or similar transport system to automatically flow or move one printed paper bag at a time from the bag digital printing system to the bag drying system. It is an object of the present invention for the method to comprise using a conveyor belt or similar transport system to automatically flow or move the printed paper bags from the bag drying system to the bag stacker for printed bags. It is an object of the present invention for the method to comprise using a conveyor belt or similar transport system to automatically flow or move one printed paper bag at a time from the bag drying system to the bag stacker for printed bags. It is an object of the present invention for the method to comprise using alignment guides when moving the printed paper bags through each system of the digital printing process. It is an object of the present invention for the method to comprise using alignment guides when moving the printed paper bags through each stage of the digital printing process. It is an object of the present invention for the method to comprise using alignment guides along the conveyor belt or similar transport system when moving the printed paper bags through each stage of the digital printing process. It is an object of the present invention for the method to comprise automatically flowing previously produced paper bags along a conveyor belt or similar transport system through each stage of the digital printing process.

The present invention relates to a method that comprises using a digital printing system. for inkjet printing that has an integrated feed system for printing paper pinch bottom bags. It is an object of the present invention for the method to comprise stacking paper pinch bottom bags for digital printing in a bag stacker connected to or attached to a conveyor belt or similar transport system. It is an object of the present invention for the method to comprise automatically flowing or moving the paper pinch bottom bags from the bag stacker to a bag feeding system by using a conveyor belt or similar transport system. It is an object of the present invention for the method to comprise automatically flowing or moving one paper bag at a time from the bag feeding system to the bag digital printing system. It is an object of the present invention for the method to comprise using a conveyor belt or similar transport system to automatically flow or move one paper pinch bottom bag at a time from the bag feeding system to the bag digital printing system. It is an object of the present invention for the method to comprise using print heads or print cartridges as part of the digital printing system to deposit ink onto each paper pinch bottom bag to form an image, images or text. It is an object of the present invention for the method to comprise using a conveyor belt or similar transport to automatically flow or move the paper pinch bottom bags from the bag digital printing system to the bag drying system. It is an object of the present invention for the method to comprise using a conveyor belt or similar transport system to automatically flow or move one paper pinch bottom bag at a time from the bag digital printing system to the bag drying system. It is an object of the present invention for the method to comprise using a conveyor belt or similar transport system to automatically flow or move the paper pinch bottom bags from the bag drying system to the bag stacker for printed bags. It is an object of the present invention for the method to comprise using a conveyor belt or similar transport system to automatically flow or move one printed paper bag at a time from the bag drying system to the bag stacker for printed bags. It is an object of the present invention for the method to comprise using alignment guides when moving the paper pinch bottom bags through each system of the digital printing process. It is an object of the present invention for the method to comprise using alignment guides when moving the paper pinch bottom bags through each stage of the digital printing process. It is an object of the present invention for the method to comprise using alignment guides along the conveyor belt or similar transport system when moving the paper pinch bottom bags through each stage of the digital printing process. It is an object of the present invention for the method to comprise automatically flowing previously produced paper bags along a conveyor belt or similar transport system through each stage of the digital printing process.

The present invention relates to a method that comprises using a digital printing system for inkjet printing that has an integrated feed system for printing paper flat bottom bags. It is an object of the present invention for the method to comprise stacking paper flat bottom bags for digital printing in a bag stacker connected to or attached to a conveyor belt or similar transport system. It is an object of the present invention for the method to comprise automatically flowing or moving the paper flat bottom bags from the bag stacker to a bag feeding system by using a conveyor belt or similar transport system. It is an object of the present invention for the method to comprise automatically flowing or moving one paper bag at a time from the bag feeding system to the bag digital printing system. It is an object of the present invention for the method to comprise using a conveyor belt or similar transport system to automatically flow or move one paper flat bottom bag at a time from the bag feeding system to the bag digital printing system. It is an object of the present invention for the method to comprise using print heads or print cartridges as part of the digital printing system to deposit ink onto each paper flat bottom bag to form an image, images or text. It is an object of the present invention for the method to comprise using a conveyor belt or similar transport to automatically flow or move the paper flat bottom bags from the bag digital printing system to the bag drying system. It is an object of the present invention for the method to comprise using a conveyor belt or similar transport system to automatically flow or move one paper flat bottom bag at a time from the bag digital printing system to the bag drying system. It is an object of the present invention for the method to comprise using a conveyor belt or similar transport system to automatically flow or move the paper flat bottom bags from the bag drying system to the bag stacker for printed bags. It is an object of the present invention for the method to comprise using a conveyor belt or similar transport system to automatically flow or move one printed paper bag at a time from the bag drying system to the bag stacker for printed bags. It is an object of the present invention for the method to comprise using alignment guides when moving the paper flat bottom bags through each system of the digital printing process. It is an object of the present invention for the method to comprise using alignment guides when moving the paper flat bottom bags through each stage of the digital printing process. It is an object of the present invention for the method to comprise using alignment guides along the conveyor belt or similar transport system when moving the paper flat bottom bags through each stage of the digital printing process. It is an object of the present invention for the method to comprise automatically flowing previously produced paper bags along a conveyor belt or similar transport system through each stage of the digital printing process.

The present invention relates to a method that comprises using computer software to send printing instructions for images or text to a digital printing system. It is an object of the present invention for the method to comprise the use of computer software to send printing instructions for an image, images or text to a digital printing system. It is an object of the present invention for the computer software to communicate with inkjet printers as part of the digital printing system to print an image, images or text on flexible and semi-rigid packaging materials. It is an object of the present invention for the computer software to communicate with laser printers that are part of the digital printing system to print an image, images or text on flexible and semi-rigid packaging materials. It is an object of the present invention for the computer software to communicate with 3D printers that are part of the digital printing system to print an image, images or text on flexible and semi-rigid packaging materials.

A system for digital printing onto a bag comprising: a digital printing system having inkjet printing; an integrated feed system; and a bag stacker for stacking bags that are fed to the bag stacker under alignment guides onto a conveyor belt. The bags are passed under the alignment guides before moving underneath the digital printing system. The inkjet printing is comprised of inkjet print heads that obtain ink from ink bottles in the digital printing system to spray ink onto a surface of the bag to form an image, images or text. A bag drying system is where bags move underneath followed by alignment guides on the way to the stacker for the printed bags. It is an object of the invention for the inkjet printing to be done with a thermal print head with an ink chamber. A resistor causes a reaction that heats ink from the ink chamber creating pressure that forces ink through nozzles in the form of ink droplets. The ink droplets are sprayed onto a printing surface or substrate to create a printed image, images or text.

It is an object of the present for the inkjet printing to be done with a non-thermal Piezoelectric print head having a single jetting or multiple jetting array and ink chamber(s). A Piezoelectric transducer(s) creates electric charge that causes a thin layer or film or crystal to vibrate, creating pressure that forces ink through nozzle(s) in the form of ink droplets. The electrical current can be switched on and off very rapidly for greater control over ink droplet formation and print density. The ink droplet is sprayed onto the printing surface or substrate which creates a printed image, images or text.

It is an object of the present invention for the digital printing unit to contain multiple ink canisters to feed ink to multiple non-thermal Piezoelectric print heads.

### BRIEF DESCRIPTION OF DRAWINGS

FIG. 1 is a digital printing system for deposition and fusing of ink or toner to a bag delivered from a reservoir with an integrated drive mechanism to deliver individual bags to the digital printing system and an integrated drive mechanism to receive and stack printed bags.

FIG. 2 is large format digital printing system for deposition and fusing of ink or toner onto a substrate fed from a roll via a drive mechanism and wound onto a roll after printing by an integrated drive mechanism.

FIG. 3 is a bag machine connected to a digital printing system connected to a bag machine with an integrated drive mechanism to be used in conjunction with the digital printing system, having a motor, transmission, and gripping apparatus to transmit bags to be printed upon to the digital printing system.

FIG. 4 is a bag machine connected to a digital printing system with an integrated drive mechanism to be used in conjunction with the digital printing system, having a motor, transmission, and gripping apparatus to receive and stack printed bags.

FIG. 5 is a digital printing system connected to a bag machine.

FIG. 6 is a digital printing system for deposition and fusing of ink to a bag delivered from a bag stacker via an integrated drive mechanism to deliver individual bags to the digital printing unit and bag drying unit and an integrated drive mechanism to receive and stack printed bags.

FIG. 7 shows an ink jet printer.

FIG. 8 shows a thermal print head.

FIG. 9 shows a non-thermal Piezoelectric print head with a single jetting array.

FIG. 10 shows a non-thermal Piezoelectric print head with multiple jetting arrays.

FIG. 11 shows the interior of a digital printing unit that contains multiple ink canisters.

### DETAILED DESCRIPTION OF THE DRAWINGS

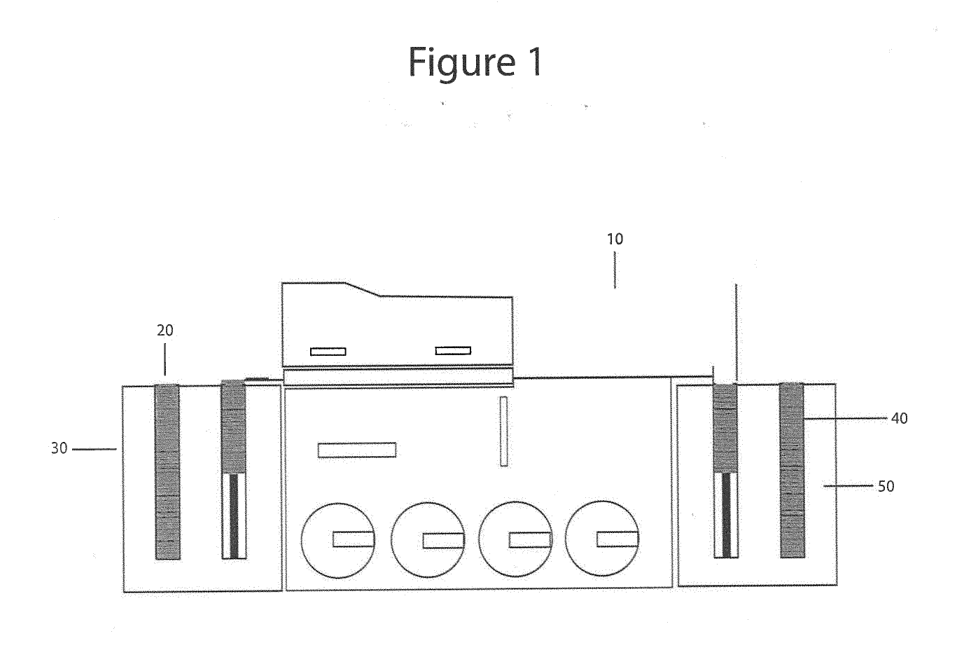

FIG. 1 shows digital printing system 10 for deposition and fusing of ink or toner to a. blank bag 20 delivered from a reservoir 30 with an integrated drive mechanism (not pictured to deliver individual bags 20 to the digital printing system 10 and an integrated drive mechanism (not pictured) to receive and stack bags that have been printed on 40 in a reservoir 50.

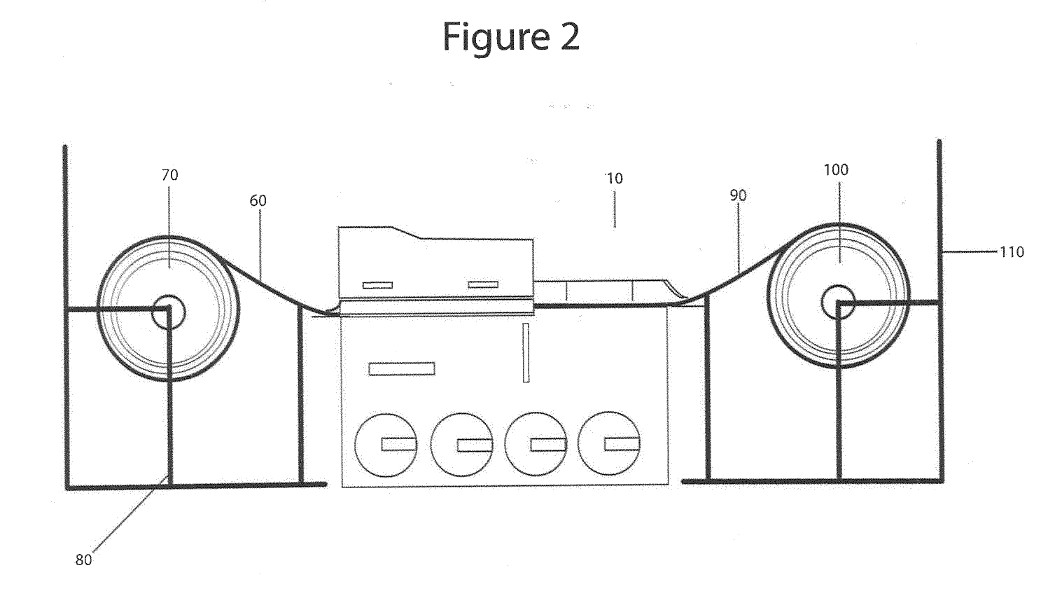

FIG. 2 shows substrate 60 being unwound from a roll 70 via an unwinder 80 and fed to a digital printing system 10 for deposition and fusing of ink or toner onto the substrate 60. The printed substrate 90 is wound on a roll 100 via a winder 110.

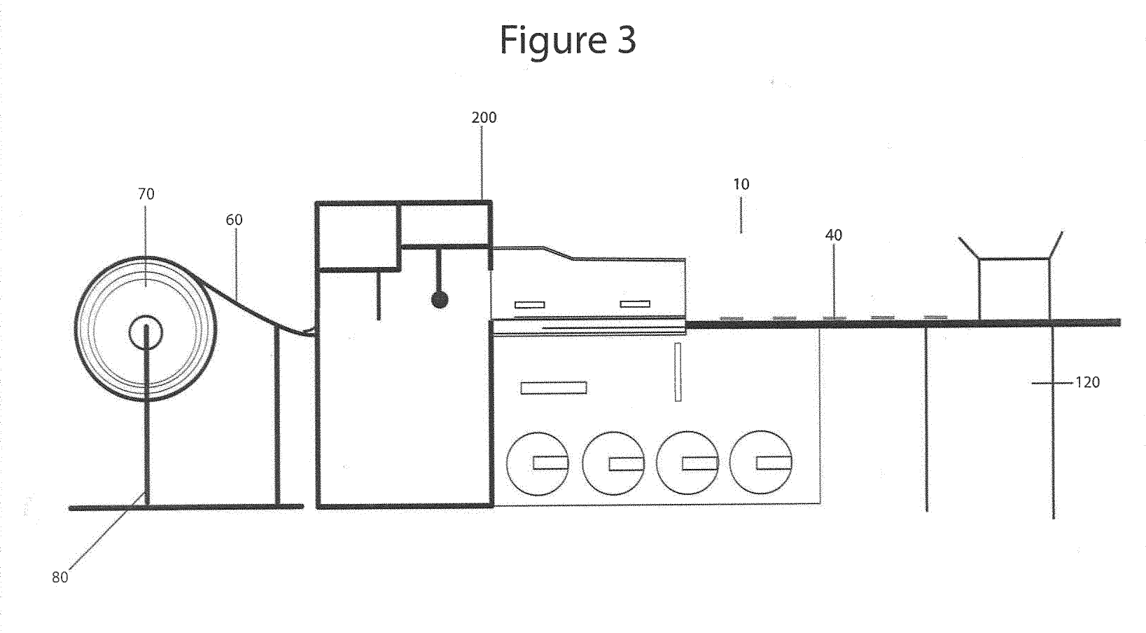

FIG. 3 shows substrate 60 being unwound from a roll 70 via an unwinder 80 and fed to a bag machine 200 for forming the substrate 60 into a bag which is then fed into a digital printing system 10 via an integrated drive mechanism (not pictured) to deliver individual bags. Printed bags 40 are received individually on a table 120 for packing.

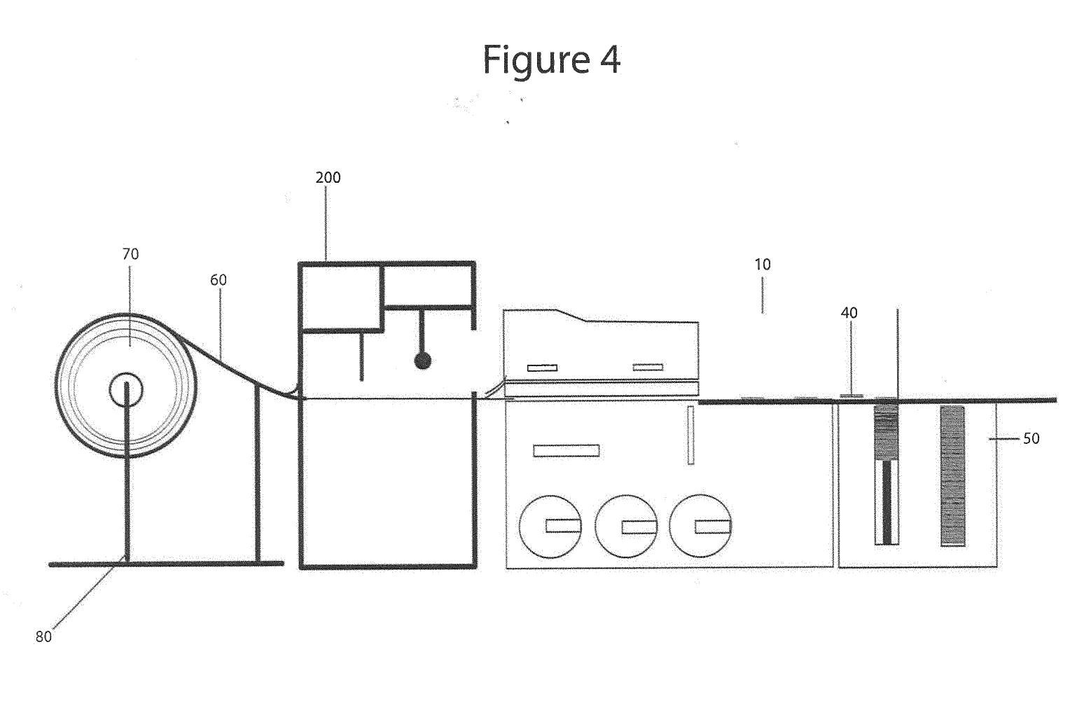

FIG. 4 shows substrate 60 being unwound from a roll 70 via an unwinder 80 and fed to a bag machine 200 for funning the substrate 60 into a bag which is then fed into a digital printing system 10 via an integrated drive mechanism (not pictured) to deliver individual bags to the digital printing system 10 and an integrated drive mechanism (not pictured) to receive and stack printed bags 40 in a reservoir 50.

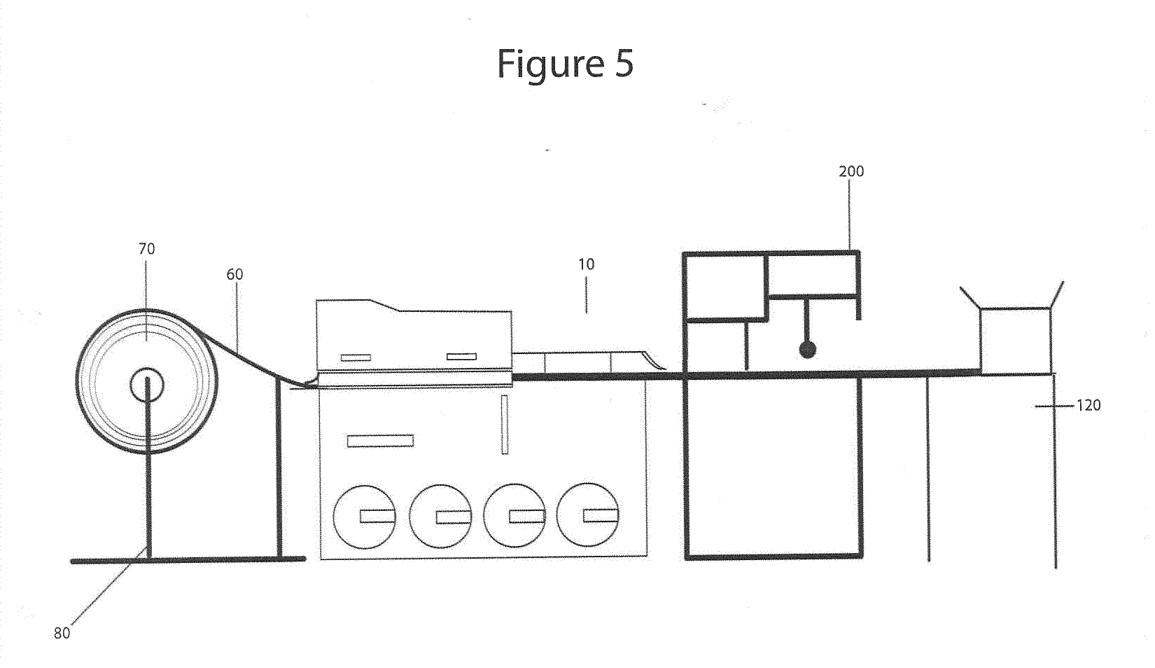

FIG. 5 shows substrate 60 being unwound from a roll 70 via an unwinder 80 and fed to a digital printing system 10 for deposition and fusing of ink or toner onto the substrate 60. Substrate 60 with printing is then fed to a bag machine 200 via an integrated device mechanism (not pictured) to deliver substrate sheet to the bag machine. Printed bags from the bag machine 200 are received on a table 120 for packing.

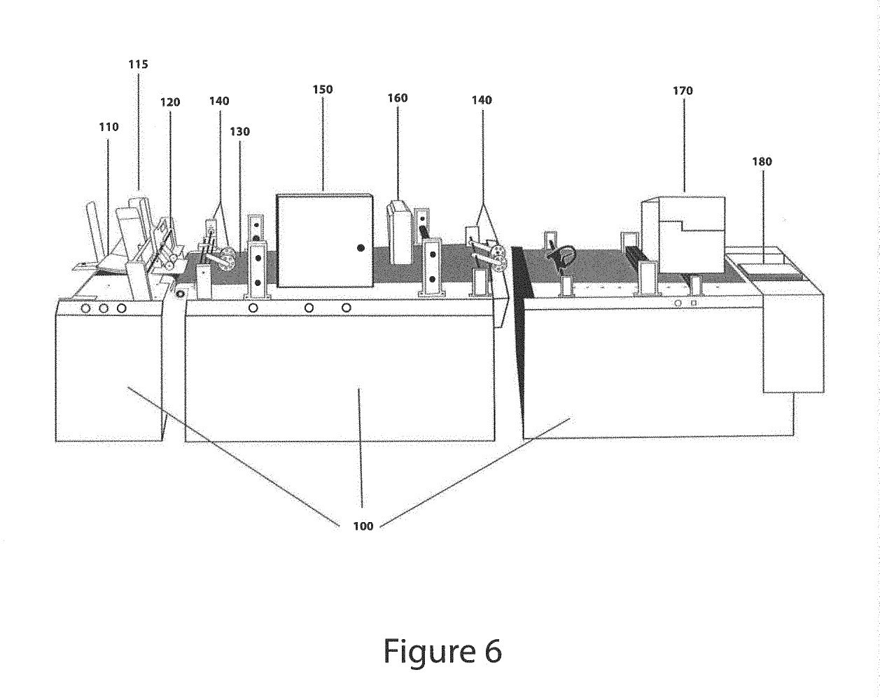

FIG. 6 shows a digital printing system 100 for inkjet printing that has an integrated feed system for printing paper bags. Bag 110 is stacked in Bag Stacker 115 and fed under alignment guides 120 onto a conveyor belt 130. Bag 110 passes under alignment guides 140 before moving underneath digital printing unit 150. Inkjet print heads (not shown) obtain ink from ink bottle (not shown) in digital printing unit to spray ink on bag surface to form image, images or text (not shown). Bag 110 moves underneath bag drying system 160, before passing under alignment guides 140 on its way to bag stacker 170 for printed bags. Bag 110 continues to bag stacker 180.

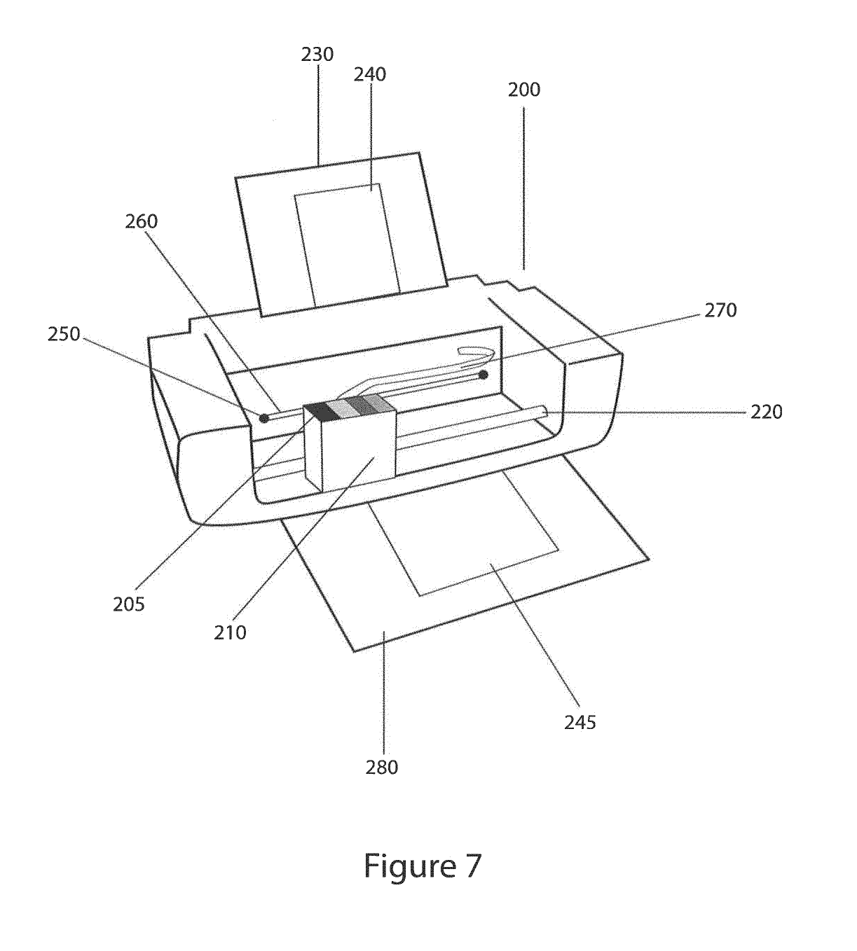

FIG. 7 shows inkjet printer 200 that has a print head 205 integrated with a print cartridge 210 positioned on sliding rod 220. Stepper motor 250 advances paper sheet 240 from upper paper tray 230 through the inkjet printer 200. Ribbon cable 270 carries printing instructions to the print cartridge 210. Drive belt 260 guides print cartridge 210 as it moves across sliding rod 220. Print cartridge 210 fires ink droplets across sheet 240 as it passes underneath print cartridge 210. Printed paper sheet 245 ends up in bottom paper tray 280.

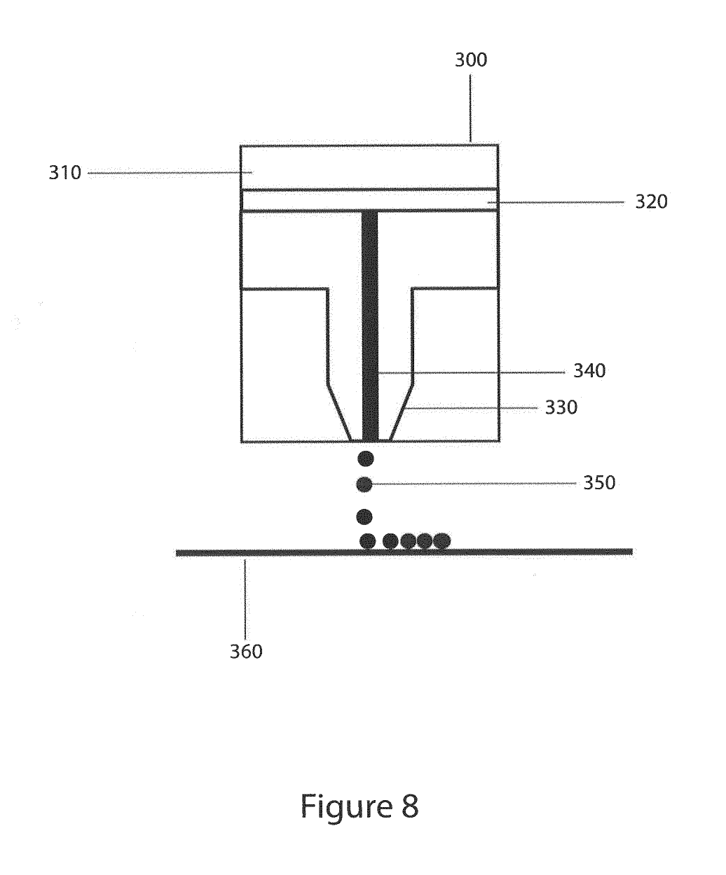

FIG. 8 shows thermal print head 300 with ink chamber 310. Resistor 320 causes a reaction that heats ink 340, creating pressure that forces ink through nozzle 330 in the form of ink droplets 350. Ink droplets get sprayed onto a printing surface or substrate 360 to create a printed image, images or text.

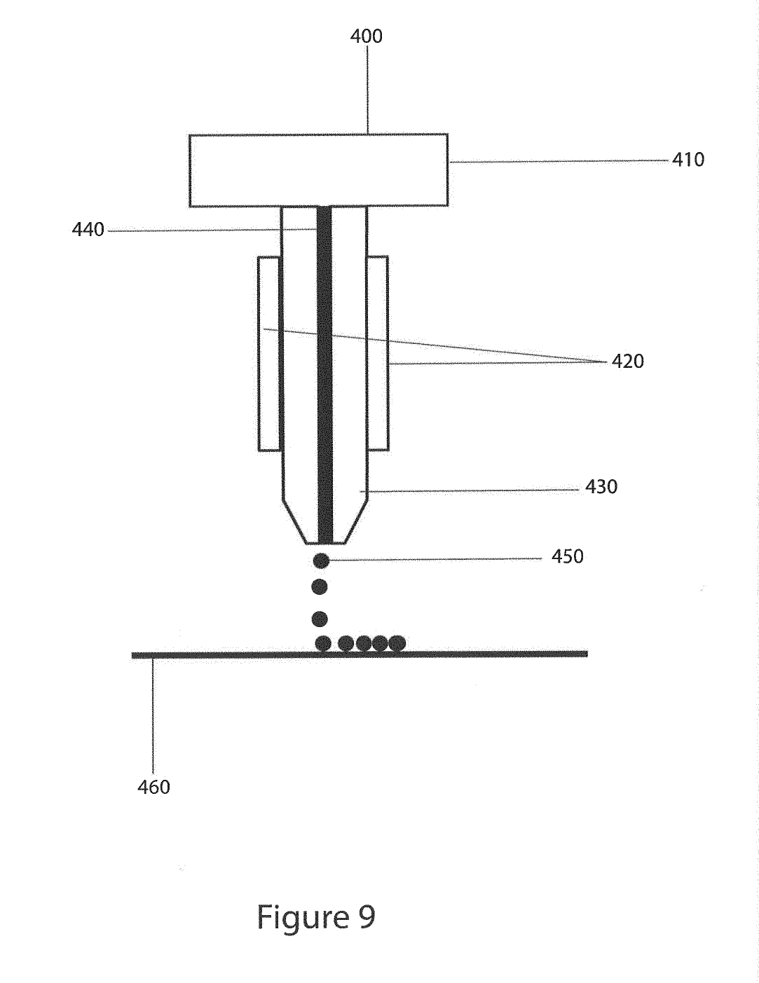

FIG. 9 shows non-thermal Piezoelectric print head 400 with a single jetting array and ink chamber 410. Piezoelectric transducer 420 creates an electric charge that causes a thin layer of film (not shown) or crystal (not shown) to vibrate, creating pressure that forces ink 440 through nozzle 430 in the form of ink droplets 450. The electrical current can be switched on an off very rapidly, allowing for greater control over the ink droplet formation and print density. Ink droplets 450 get sprayed onto a printing surface, or substrate 460 to create a printed image, images or text.

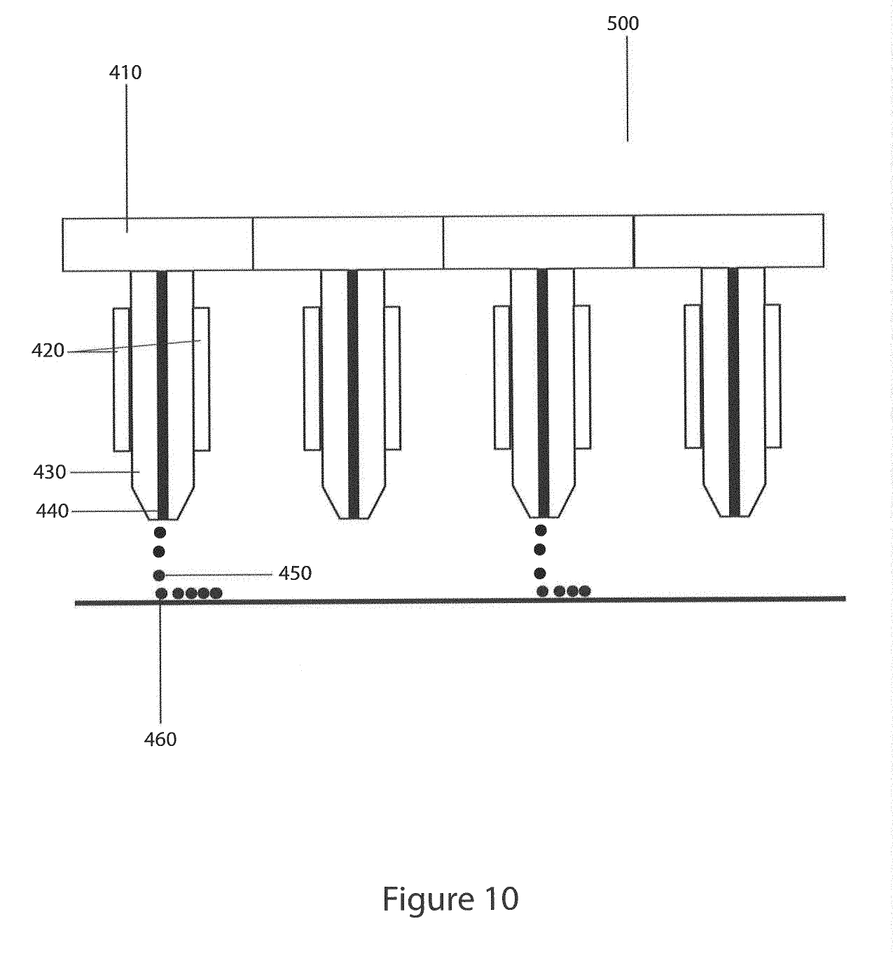

FIG. 10 shows non-thermal Piezoelectric print head 500 with multiple jetting arrays and ink chambers 410. Piezoelectric transducers 420 create electric charges that cause a thin layer of film (not shown) or crystal (not shown) to vibrate, creating pressure that forces ink 440 through nozzles 430 in the form of ink droplets 450. The electrical current can be switched on an off very rapidly, allowing for greater control over the ink droplet formation and print density. Ink droplets 450 get sprayed onto a printing surface or substrate 460 to create a printed image, images or text.

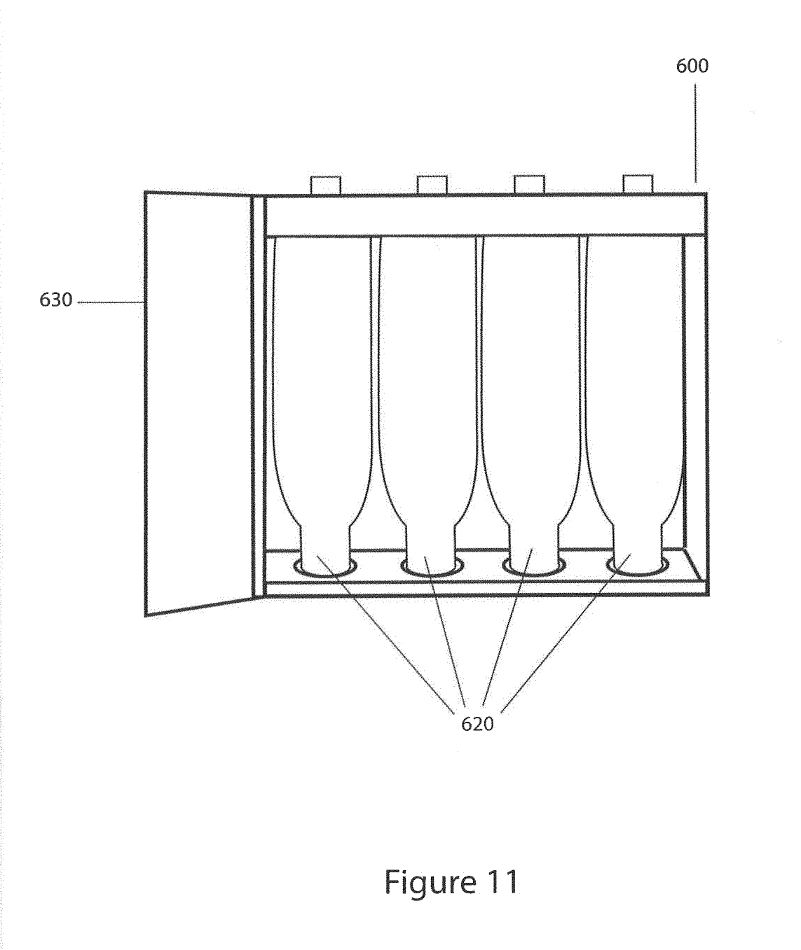

FIG. 11 shows the interior of a digital printing unit 600 with door 630 in the open position to make contents of digital printing unit visible. Digital printing unit 630 contains multiple ink canisters 620 designed to feed ink (not shown) to multiple non-thermal Piezoelectric print heads (not shown).

1. A method for printing black and white or color graphics and/or text on preprinted paper bags comprising:
feeding said preprinted bags separately produced on a bag machine to a separate digital printing system for additional printing using single or multiple color graphics or text;
using said digital printing system to deposit a further deposition of ink or toner onto surface of said preprinted bags to form an image, images or text other than what is already preprinted on said bags.

2. The method of claim 1 wherein said bags are flat bottom bags or pinch bottom bags.

3. A method for printing black and white or color graphics or text on paper bags comprising:
using a digital printing system that uses inkjet printing wherein print head(s) or print cartridge(s) deposit ink against surface of said paper bags;
forming an image, images or text on said paper bags, wherein said inks are water-based inks, oil based inks, eco-solvent based inks, and solvent based inks.

4. The method of claim 3 wherein said print head(s)or print cartridge(s) are comprised of jetting array(s) to deposit ink against the surface of said paper bags.

5. The method of claim 3 wherein said inkjet printing features CMYK print heads or print cartridges that each have up to four jetting arrays, with each jetting array depositing a single color of ink on a surface of said bags.

6. The method of claim 3 wherein increasing number of jetting arrays increases vertical DPI and decreasing number of jetting arrays decreases vertical DPI.

7. The method of claim 3 wherein said inkjet print head(s) or print cartridge(s) achieve a vertical print capacity or width of up to six inches on a surface of said bags.

8. The method of claim 3 wherein said inkjet printing features at least two print heads stitched together to achieve a vertical print capacity or width of up to six inches on a surface of said bags.

9. The method of claim 3 wherein said inkjet printing uses drop-on-demand print heads such as thermal print heads, non-thermal print heads or a combination to deposit ink onto bags to form an image, images or text.

10. The method of claim 3 wherein said bags are unprinted or preprinted, and if preprinted a further deposition of ink on said bags other than what is already preprinted on said bags.

11. The method of claim 10 wherein said bags are pinch bottom bags or flat bottom bags.

12. The method of claim 3 wherein said inkjet printing is controlled by a computer system.

13. The method of claim 12 wherein said computer system directs movement of each print head or print cartridge across said bags to create said printed image, images or text.

14. The method of claim 3 wherein said inkjet printing features thermal print heads to deposit ink on said bags to form said image, images, or text.

15. The method of claim 14 wherein said thermal print heads are comprised of single or multiple jet arrays to deposit aquas or water-based ink on said bags.

16. The method of claim 14 wherein said thermal print heads deposit up to four colors of ink comprising some combination of black, cyan, magenta and yellow inks on said bags.

17. The method of claim 9 wherein said bags are unprinted or preprinted bags, and if preprinted a further deposition of ink on said bags other than what is already preprinted on said bags.

18. The method of claim 17 wherein said bags are pinch bottom bags or flat bottom bags.

19. The method of claim 3 wherein said inkjet printing features non-thermal print heads using piezoelectricity called Piezo print heads to deposit ink on bags to form image, images or text.

20. The method of claim 19 wherein said Piezo print heads are comprised of single or multiple jetting arrays to deposit ink on said bags.

21. The method of claim 19 wherein said Piezo print heads control size of ink droplet or droplets deposited on said bags to increase print resolution.

22. The method of claim 21 wherein said Piezo print heads print up to 6,000 dots per inch of ink on said bags approaching photo quality printing.

23. The method of claim 21 wherein said Piezo print heads print 300, 600, 900, or 1,200 dots per inch of ink of said bags.

24. The method of claim 22 wherein said dots per inches of ink is measured on both a vertical and horizontal basis, vertical or widthwise basis, or horizontal or lengthwise basis on said bags.

25. The method of claim 24 wherein said Piezo print heads print vertical dots per inch equal to horizontal dots per inch on said bags.

26. The method of claim 24 wherein said Piezo print heads print vertical dots per inch of ink different in quantity from horizontal dots per inch of ink on said bags.

27. The method of claim 19 Wherein said bags are unprinted or preprinted and if preprinted a further deposition of ink on said bags other than what is already preprinted on said bags.

28. The method of claim 27 wherein said bags are either pinch bottom bags or flat bottom bags.

29. The method of claim 19 wherein said Piezo print heads print cyan, magenta, yellow and black images or CMYK images or text using UV curable inks on said bags.

30. The method of claim 19 wherein said Piezo print heads yield a vertical print capacity or printing width on said bags ranging from 0.25 inches to 6 inches.

31. The method of claim 19 wherein said Piezo print heads yield a vertical print capacity or printing width on said bags ranging from 0.25 inches to 10 inches.

32. The method of claim 3 wherein said print head(s) or print cartridge(s) ink is obtained for printing from integrated inkjet system receptacles wherein each inkjet receptacle has a single color of ink.

33. The method of claim 3 wherein said digital printing system further comprises an integrated feed system for printing bags.

34. The method of claim 3 further comprising:
stacking bags for digital printing in a bag stacker connected to or attached to a conveyor belt or similar transport system.

35. The method of claim 34 further comprising:
automatically flowing or moving said bags from a bag stacker to a bag feeding system by using said conveyor belt or similar transport system.

36. The method of claim 35 further comprising:
automatically flowing or moving one bag at a time from said bag feeding system to bag digital printing system using a conveyor belt or similar transport system.

37. The method of claim 3 wherein said digital printing system comprises electronics including software to control operation of said system, print heads, print cartridges and ink bottles or ink canisters.

38. The method of claim 3 further comprising:
using a conveyor belt or similar transport to automatically flow or move a single bag or multiple bags from said digital printing system to a bag drying system.

39. The method of claim 38 further comprising:
using a conveyor belt of similar transport system to automatically flow or move a single bag or multiple bags from said bag drying system to a bag stacker for printed bags.

40. The method of claim 3 further comprising:
using alignment guides when moving said bags through each system of said digital printing process.

41. The method of claim 3 further comprising:
using alignment guides along conveyor belt or similar transport system when moving said bags through each stage of said digital printing process.

42. The method of claim of claim 3 further comprising:
automatically flowing previously produced bags along a conveyor belt or similar transport system though each stage of said digital printing process.

43. The method of claim 3 wherein said digital printing system uses mobile digital printing unit(s) that are moved to different printers;
said mobile digital printing unit(s) using said inkjet printing with print head(s) or print cartridge(s) that print a single color or multiple colors;
connecting more than one mobile digital printing units to said digital printing system so that each mobile printing unit prints one or more ink colors on said bags.

44. The method of claim 43 wherein said bags are unprinted or preprinted and if preprinted a further deposition of ink on said bags is other than what is already preprinted on said bags.

45. The method of claim 44 wherein said bags are pinch bottom or flat bottom bags.

46. The method of claim 45 further comprising:
using computer software to send printing instructions for image, images or text to said inkjet printers as part of said digital printing system.

47. The method of claim 3 further comprising:
using computer software to send printing instructions for image, images or text to said inkjet printers as part of said digital printing system.

48. The method of claim 3 wherein said printer is a laser printer that is part of said digital printing system that uses computer software to print image, images or text on said bags.

49. The method of claim 3 wherein said printer is a 3D printer that is part of said digital printing system that uses computer software to print image, images or text on said bags.

50. The method of claim 3 wherein said bags to be printed are in form of substrate that is unwound from a roll via an unwinder and fed to said digital printing system for deposition and fusing of ink or toner onto surface of substrate.

51. The method of claim 50 further comprising:
winding said substrate having deposition and fusing of ink.

52. The method of claim 51 wherein said substrate is unwound from said roll via an unwinder and fed to a bag machine to form said substrate into a bag.

53. The method of claim 52 wherein said printed bags are received individually on a table for packing.

54. The method of claim 3 wherein said bags to be printed are in form of substrate that is unwound from a roll via an unwinder and fed to a bag machine for forming substrate into a bag that is then fed into said digital printing system via integrated drive mechanism where said bags are printed and then said individual bags are moved via an integrated drive mechanism to receive and stack printed bags in a reservoir.

55. A system for digital printing onto a bag comprising:
a digital printing system having inkjet printing;
an integrated feed system;
a bag stacker for stacking bags that are fed to said bag stacker under alignment guides onto a conveyor belt;
said bags are passed under said alignment guides before moving underneath said digital printing system;
said inkjet printing comprised of inkjet print heads that obtain ink from ink bottles in said digital printing system to spray ink onto a surface on said bag to form image, images or text;
a bag drying system where said bags move underneath followed by alignment guides on way to bag stacker for said printed bags.

56. The system of claim 55 wherein said inkjet printing is done with a thermal print head with an ink chamber;
a resistor causing a reaction that heats ink from said ink chamber creating pressure that forces ink through nozzle(s) in form of ink droplets;
said ink droplets are sprayed onto a printing surface or substrate to create a printed image, images or text.

57. The system of claim 55 wherein said inkjet printing is done with a non-thermal Piezoelectric print head having a single jetting or multiple jetting array and ink chamber(s);
a Piezoelectric transducer(s) creates electric charge that causes a thin layer or film or crystal to vibrate, creating pressure that forces ink through nozzle(s) in form of ink droplets;
electrical current is switched on and off very rapidly for greater control over ink droplet formation and print density;
said ink droplet sprayed onto printing surface or substrate creates a printed image, images or text.

58. The system of claim 57 wherein said digital printing unit contain multiple ink canisters to feed ink to multiple non-thermal Piezoelectric print heads.
